(19) United States
(12) Patent Application Publication
(10) Pub. No.: US 2025/0056324 A1
(43) Pub. Date: Feb. 13, 2025

(54) Systems and Methods to Provide Network Services to User Devices

(71) Applicant: HUAWEI TECHNOLOGIES CO., LTD., SHENZHEN (CN)

(72) Inventor: Ngoc Dung DAO, Kanata (CA)

(73) Assignee: HUAWEI TECHNOLOGIES CO., LTD., SHENZHEN (CN)

(21) Appl. No.: 18/931,227

(22) Filed: Oct. 30, 2024

Related U.S. Application Data
(63) Continuation of application No. PCT/CN2022/093796, filed on May 19, 2022.

(51) Int. Cl. H04W 28/16; H04W 4/50; H04W 92/24

(52) U.S. Cl. CPC H04W 28/16; H04W 4/50; H04W 92/24

(57) ABSTRACT

Systems and methods to provide network services to user devices are described. One method includes receiving a control plane (CP) message at an interface function of an access network (AN). The method further includes selecting, based on the CP message, a CP interface from a plurality of CP interfaces between the AN and a core network (CN) of a mobile network. The method further includes transmitting the CP message to the CN using the selected CP interface. Selecting a CP interface may include selecting a CP interface based on an indicator included in the CP message. Selecting a CP interface may include selecting a CP interface between a first CP interface used for device-centric CP signaling and a second CP interface used for network-centric CP signaling.

This application is a continuation of International Application No. PCT/CN2022/093796, filed on May 19, 2022, the disclosure of which is hereby incorporated by reference in its entirety.

### TECHNICAL FIELD

The present invention pertains to the field of communication networks, and in particular to systems and methods to provide network services to user devices.

### BACKGROUND

A fifth generation (5G) mobile network provides a variety of services to mobile devices and provides data connections between one or more mobile devices and one or more data networks (DNS). However, as the number of services increases, 5G network architecture may be inadequate to efficiently accommodate the increasing number of services. For example, 5G network architecture may not be flexible enough to support certain new services, such as services which may be delay-sensitive. Under existing 5G network architecture, all data packets from a mobile device may need to go through the user plane (UP) to the DN, even if the data packet is meant to be sent to the mobile network. This limitation may cause undue delay in delay-sensitive applications. In addition, 5G network architecture may limit how control plane (CP) signalling may be conducted.

Therefore, there is a need for systems and methods to provide network services to user devices that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The present disclosure provides for systems and methods to provide network services to user devices.

According to one aspect, a method is provided which includes receiving a CP message at an interface function of an access network (AN). The method further includes selecting, based on the CP message, a CP interface from a plurality of CP interfaces between the AN and a core network (CN) of a mobile network. The method further includes transmitting the CP message to the CN using the selected CP interface. The method may reduce traffic load on the CP interfaces by separating the traffic based on the CP message.

Selecting a CP interface may include selecting a CP interface based on an indicator included in the CP message. Selecting a CP interface may include selecting a CP interface between a first interface and a second interface. The first interface may be an interface used for electronic device (ED)-centric CP signaling, including access and mobility CP messages. The second interface may be an interface used for network-centric CP signaling. The CP message may include a message for discovering a network service. In some embodiments of the first aspect, selecting a CP interface includes selecting the first interface. The CP message may include a message for accessing a network service and selecting a CP interface may include selecting the second interface. The method may improve security protection for one or more of ED-centric data connection services and network-centric services, as the associated CP interfaces are isolated from each other. The method may further allow for separate mobility handling for ED-centric data connection services and network-centric data, based on separate CP interfaces.

Receiving a CP message may include receiving a CP message from an ED, and transmitting the CP message to the CN may include transmitting the CP message to a service provider function (SPF) associated with the CN. Receiving a CP message may include receiving a CP message at an ED-AN interface function (EAIF).

In one aspect, a method of providing services to an electronic device (ED) from an EAIF is disclosed. The method include receiving, by an EAIF, a request for service from the ED, where the service is provided by a service provider function (SPF) in a core network (CN) of a mobile network, and where the EAIF is associated with an access network (AN) and transmitting the request for service over a first interface between the AN and the CN. The method also includes receiving a first response indicating that the ED is authorized to use the service, assigning one or more AN resources to service data communication between the ED and the SPF, and sending, to the ED, a second response based on the first response. The method may allow for an ED to discover and request for one or more services of a network.

In the method, receiving a request can include receiving a request including one of more of an ED identifier (ID), an ED location, an application ID, a service ID, destination information, a data network name (DNN), a network slice ID, a location of the requested service, data to be analyzed, a travel path, a waypoint, a location and a corresponding time window, an accuracy of road analytic information, a type of road analytic information. Transmitting the request for service may include transmitting the request for service through one or more of an AN ED-centric interface function (ECIF) and a CN ECIF. Receiving the first response may include receiving the first response through one or more of an AN ECIF and a CN ECIF. Receiving a first response may include receiving a first response including one of more of an ED identifier (ID), an ED location, an indication of service acceptance or service rejection, a cause for service rejection when an indication of service rejection is present, a service location, a time window for the service, a network function (NF) ID of the SPF, address information of the SPF, a service ID, an application ID, a data network name (DNN), a network slice information, a NF ID of a selected CN network-centric interface function (NCIF), a NF ID of a selected AN NCIF, and a EAIF NF ID.

Sending a second response may include sensing a second response including one or more of an ED identifier (ID), an indication of service acceptance or service rejection, a cause for service rejection when an indication of service rejection is present, a service location, a time window for the service, a network function (NF) ID of the SPF, address information of the SPF, a service ID, an application ID, a data network name (DNN), a network slice information.

The method can also include receiving, from the ED, a data message associated with the service, sending the data message toward the SPF, receiving, from the SPF, a service result message based on the data message, and sending, to the ED, the service result message. Receiving a data message may include receiving a data message including one or more of a destination information associated with the SPF, a data network name (DNN), a network slice identifier (ID), and a service container message. Sending the data message toward the SPF may include sending the data message toward the SPF via one or more of an AN NCIF and a CN NCIF. The method may allow for requesting a service of the network and sending the request directly to the CN function that provides the service. Receiving a service result message may include receiving a service result message including one or more of a destination information associated with the EAIF, an ED identifier, and an ED container message, wherein the ED container message comprises one or more of: an ED ID, a service request ID, a service acknowledgment to indicate that the service requested is fulfilled, a list of detected objects and their corresponding attributes, an accuracy (or reliability) of object detection, and a timestamp of the service result message. Receiving a service result message may include receiving a service result message via one or more of an AN NCIF, and a CN NCIF. Corresponding attributes of a detected object includes one or more of: a description of the object, a description of the object's size, a location of the object, a 2D relative distance to the ED, and a 3D relative distance to ED. The method may allow for separation of mobility management and service management.

In another aspect, a method by an EAIF is described. The method includes receiving, by an EAIF, a service request from an electronic device (ED) and determining whether the request is directed to a service provider function (SPF) in a core network (CN) of a mobile network. The method further includes sending the request for service toward the SPF, receiving, from the SPF, a service response based on the request, and sending, to the ED, the service response. The method may allow for an ED to directly request one or more services of the network. The method may further allow the ED to access the one or more services of the network.

Receiving a service request may include receiving a service request including one or more of: an ED identifier (ID), an ED location, application ID, a service ID, destination information, a data network name (DNN), a network slice ID, a location of the requested service, data to be analyzed, a time stamp, and a deadline. Sending the request for service toward the SPF may include sending the request for service toward the SPF via one or more of an AN NCIF, and a CN NCIF. Receiving a service response may include receiving, from the SPF, a service response including one or more of: an ED identifier (ID), an ED location, a network slice ID, return data, a servicer request ID, a network function (NF) ID of the SPF. Receiving a service response may include receiving a service response via one or more of an AN NCIF and a CN NCIF.

The method may further include receiving, from the ED, a message to unsubscribe to the service, the message comprising a service request identifier (ID) associated with the request for service, sending the message to unsubscribe toward the SPF, receiving, from the SPF, an acknowledgment response based on the message to unsubscribe, and sending, to the ED, the acknowledgement response.

In one aspect, a method by a network function (NF) in an access network (AN) is described. The method includes transmitting an AN NF registration message to an NF database in a core network (CN) of a mobile network, the message including a request to register a service in the NF database, and receiving, from the NF database, a registration response. Transmitting an AN NF registration message may include transmitting an AN NF registration message including one or more of a network ID associated with the mobile network, an access technology (AT) type, an AT ID, an AN ID, a network slice ID, an ID of the NF, an address of the NF, a type of data, location information, and operating hours indicative of a time window. Transmitting an AN NF registration message may include transmitting an AN NF registration message via one or more of an AN NCIF and a CN NCIF. The method may allow an AN NF to register its services in a CN NF database. The method may further allow the NFs in the CN to request and access the services provided by the AN NF.

Transmitting an AN NF registration message may include transmitting an AN NF registration message including one or more of: a geographic location, a type of data collected, and a type of service. Transmitting an AN NF registration message including a geographic location may include transmitting an AN NF registration message including one or more of: a two-dimensional location, a three-dimensional location, a civic address, the AN ID, and a cell ID. Transmitting an AN NF registration message including a type of data collected may include transmitting an AN NF registration message including one or more of: an image, a video, a vehicle-to-vehicle everything message, a radar, a LIDAR, a temperature, a count of vehicle traffic, and a count of non-vehicle traffic.

Transmitting an AN NF registration message including a type of service may include transmitting an AN NF registration message indicating one or more of: a sensory data collection service, an artificial intelligence service, a machine learning service, a federating learning, a split learning, a supervised learning, an unsupervised learning, and a reinforcement learning.

Receiving, from the NF database, a registration response may include receiving, from the NF database a registration response indicating that the NF is registered in the NF database.

In one aspect, a method of providing a service to an electronic device (ED) by a service provider function (SPF) in a core network (CN) of a mobile network is disclosed. The method includes receiving a request for the service, the request associated with the ED and received from an EAIF, sending, to a service authorization function, a request to authorize the ED to use the service, receiving, from the service authorization function, a response indicating that the ED is authorized to use the service, and sending, to the EAIF, a service response.

Receiving a request for the service may include receiving a request for the service via one or more of an AN ECIF and a CN ECIF. Receiving a response may include receiving a response including one or more of a location where the ED can use the service and a time window for the ED to use the service. The method may further include selecting one or more of an AN NCIF and a CN NCIF and wherein sending the service response comprises sending the service response indicating the selection of the one or more of the AN NCIF and the CN NCIF. The method may further include receiving, from the EAIF, a service data transmission associated with the service, processing the service data transmission, and transmitting a service result toward the ED based on the processed service data transmission. Transmitting the service result may include transmitting a service result including one or more of a destination selection, an identification of the ED, and an ED container message.

In another aspect, the present disclosure provides a method by a data processing function (DPF) in a core network (CN) of a mobile network. The method includes receiving, from a data consumer function (DCF) in the CN of the mobile network, a request for data and selecting, based on the request for data, a data source from one or more of: an access network (AN), a network function (NF) in the AN, and an electronic device (ED). The method also includes transmitting the request for data to the selected data source, receiving data based on the transmitted request for data, and sending the received data to the DCF. Receiving a request for data may include receiving a request for data including one or more of: an identifier (ID) of the DCF, a service request ID associated with the request, a geographic location, a type of object to be detected, a type of data, an observation time window, a sampling time duration, and a moving direction of object. The method may allow a function in the CN, such as a data consumer function, to request for or subscribe to one or more types of data in one or more of: another network, an AN, NF and ED.

Selecting a data source may include transmitting a request to a database NF to determine a NF that can provide the requested data, the request including one or more of location information, a type of data, an observation window, a network identifier (ID), and an AN ID, and receiving a response from the database NF, the response indicating the NF that can provide the requested data. Transmitting the request for data may include transmitting the request for data via one or more of: an AN NCIF and a CN NCIF. Receiving data may include receiving data including one or more of a service request identifier (ID) associated with the request for data; a time stamp of the received data, an AN ID, an AN node ID, an AN cell ID, an ID of the AN DGF, a network ID, a network slice ID, a CN ID, an ID of the ED, a location ID, a type of data, the data, and parameters to read the data. Sending the received data may include processing the received data to generated processed data, wherein processing comprises one or more of removing private information from the received data, storing the received data in a data storage function, and storing the processed data in the data storage function, and sending, to the DCF, the processed data.

According to another aspect, an apparatus is provided. The apparatus includes modules configured to perform one or more of the methods described herein.

According to one aspect, an apparatus is provided, where the apparatus includes: a memory, configured to store a program; a processor, configured to execute the program stored in the memory, and when the program stored in the memory is executed, the processor is configured to perform one or more of the methods described herein.

According to another aspect, a computer readable medium is provided, where the computer readable medium stores program code executed by a device and the program code is used to perform one or more of the methods described herein.

According to one aspect, a chip is provided, where the chip includes a processor and a data interface, and the processor reads, by using the data interface, an instruction stored in a memory, to perform one or more of the methods described herein.

Other aspects of the disclosure provide for apparatus, and systems configured to implement the methods according to the first aspect disclosed herein. For example, wireless stations and access points can be configured with machine readable memory containing instructions, which when executed by the processors of these devices, configures the device to perform one or more of the methods described herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates a mobile network architecture, according to an aspect of the present disclosure.

FIG. 2 illustrates an example of network deployment, according to an aspect of the present disclosure.

FIG. 3 illustrates a communication protocol between an access network (AN) and a core network (CN), according to an aspect of the present disclosure.

FIG. 4 illustrates a procedure for registering, in the core network, a network function of the access network, according to an aspect of the present disclosure.

FIG. 5 illustrates the mobile network architecture of FIG. 1 with additional network functions and services, according to an aspect of the present disclosure.

FIG. 6 illustrates a procedure for a function in the CN to receive sensing data from the AN, according to an aspect of the present disclosure.

FIG. 7 illustrates a communication protocol between an electronic device (ED) and the mobile network, according to an aspect of the present disclosure.

FIGS. 8A and 8B illustrate a procedure for an ED to obtain a real-time service from the mobile network, according to an aspect of the present disclosure.

FIGS. 9A and 9B illustrate a procedure for an ED to obtain a service from the mobile network, according to an aspect of the present disclosure.

FIG. 10 illustrates an apparatus that may perform any or all of operations of the above methods and features explicitly or implicitly described herein, according to different aspects of the present invention.

FIG. 11 illustrates a method for communicating between an AN and a CN, according to an aspect of the present disclosure.

It will be noted that throughout the appended drawings, like features are identified by like reference numerals.

### DETAILED DESCRIPTION

The fifth generation (5G) mobile network can provide diversified services for mobile devices. The network can deliver a high-speed data connection, low packet delay, and multi-edge computing (MEC) support. The network can also provide network information to a third party, such as real-time network performance and network data analytics, so that the third party can select better communication parameters to improve the quality of data communication services. For example, a 5G mobile network can provide network quality of services (QOS) statistics or prediction at certain cell of radio access network. The QoS information can be used by communication devices in the network, for example, vehicles equipped with sensors, to select proper transmission data rate of sensors installed in the vehicles.

In the future, networks may also provide enhanced sensing services and artificial intelligence (AI) and/or machine learning (ML) services to user devices and third-party application servers.

For example, these services may be used by vehicles which have data connections with the application server for advanced driving control, coordination, and safety improvement. As the number of vehicles increase, use of enhanced sensing services and AI/ML services may be more desirable. Vehicle travel times may be dependent on vehicle and non-vehicle traffic, including pedestrian, cyclists, motorists and the like. Estimating the number of vehicles on road may be useful for determining travel time among other applications. Currently there are some methods for estimating the number of vehicles on road, but these methods may be improved.

Additionally, map service providers may provide information on the number of vehicles currently using map services and the number of vehicles connected to the map server. However, information (such as the number of vehicles and non-vehicle traffic) provided by map service provides may be inaccurate for a number of reasons: some GPS devices may not have internet connections or may be in offline mode, or some non-vehicle users may not have internet connections.

Further, an intelligent transport system (ITS) may use wireless connections to control traffic lights and provide information like traffic and road condition updates to vehicles. The ITS may employ cameras and sensors in light posts, for example, for various applications including counting the number of vehicles on road. The ITS may be leveraged via an extensive network of radio base stations (and other possible radars and sensors integrated with antennas), which can provide information including location estimates with high accuracy. Accordingly, the mobile network operators may have advantages in deploying a new system to support ITS and vehicles to select improved travel paths.

Therefore, it may be desired to provide systems and methods which provide of sensing and AI/ML services to user devices and third-party application entities. These systems, including network functions, can support low delay data communication and may further provide a method for collecting sensing data. The data format may be any types of data such as data packets, voice data, video data. These systems may further provide a method for provisions of AI/ML services.

This proliferation of additional services may also place more strain on network architecture. It may, therefore, be beneficial to provide additional interfaces to support this additional data traffic. For example, a core network (CN) and access network (AN) can have three interfaces: two logical control plane (CP) interfaces and one logical user plane (UP) interface. One of the two CP interface can support device-centric services such as data connection with third party services. The other CP interface can support network-centric services, such as sensing and AI/ML services, provided by the mobile network. This may contrast with prior networks, such as 5G networks, which included only a single logical CP interface, namely N2 interface between the AN and CN. This improved network architecture may be used to provide a wide variety of services, such as collecting data to be used for road traffic analytics (RTA).

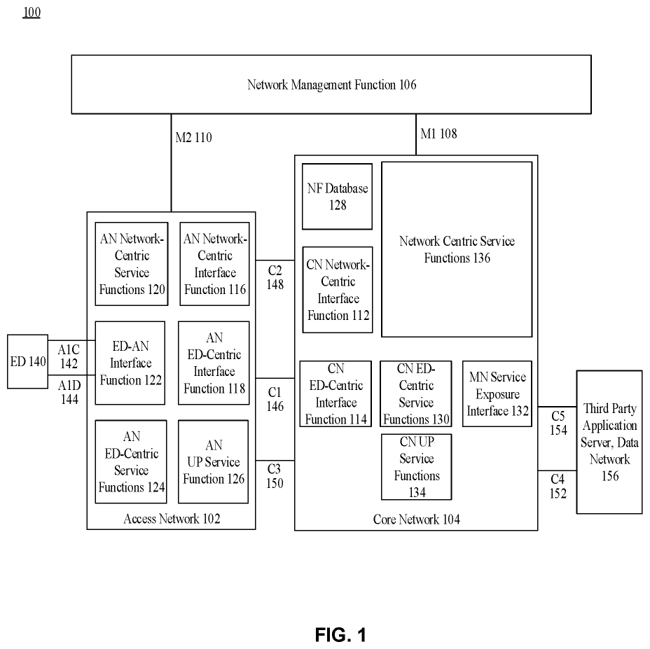

FIG. 1 illustrates a mobile network architecture 100, according to an aspect of the present disclosure. The network architecture 100 includes an AN 102 and a CN 104.

The AN 102 can provide data connections between an electronic device (ED) 140 and the CN 104 via wired or wireless connections. The AN 102 can also provide services to the ED 140. The CN 104 can provide control and service functionalities for the ED 140. The CN 104 can also provide data connections for the ED 140 with a third-party data network (DN) 156, such as the Internet.

The ED 140 may be any network-connected device. For example, the ED 140 may be a user device, such as a smart phone, smart watch, TV or other device, or may be other types of devices such as video camera or a photo camera installed in, e.g., a dwelling, a shopping mall, an office building, a vehicle, a street, or a highway. The ED 140 may be other types of network-connected devices as well, such as a radar or a light detection and ranging (LIDAR) device installed in a vehicle, lamp posts, or elsewhere. The ED 140 may also include a wide variety of other types of devices.

The AN 102 may be a radio access network (RAN) that uses wireless technologies such as Wi-Fi, fourth-generation (4G), fifth generation (5G), or other wireless technologies. The AN 102 may use cables (e.g., fiber optic, coaxial, copper) to provide wired connections for the ED 140.

The network architecture 100 includes three logical interfaces between the AN and the CN. A first logical interface, C1 146, can be a control plane (CP) interface for ED-centric connection services. The ED-centric connection services could be used for controlling data connections between ED 140 and third-party application servers in data network 156. A second logical interface, C2 148, can be another CP interface for new services which may be provided by NF of CN 104. A third logical interface, C3 150, can be a UP interface for data transfer between the AN and CN. The terminology interface may be used interchangeably with logical interface, as may be appreciated by a person skilled in the art.

Having two separate CP interfaces 146, 148 may provide benefits over having a single CP interface. Separate CP interfaces may improve security protection for ED-centric data connection services. The second interface, C2 148, may provide services to the CN and further provide services to a third party. The C2 interface 148 can be isolated from the first interface 146 thereby preventing or reducing the likelihood of impact to data connection services in case the C2 interface 148 is unavailable due to service outage, overloaded, or other reasons.

Having separate CP interfaces 146, 148 may allow for separating control traffic load of network-centric data from ED-centric data. This may improve traffic flow routing and management.

Having separate CP interfaces 146, 148 may allow for separating mobility handling for ED-centric data connection services and network-centric data. For example, when an ED 140 with high mobility has data connections with a third-party data network, the data gateway and CP 104 functions may be selected far from the ED 140 location to avoid frequent handover when the ED 140 moves to a new location. At the same time, the ED 140 may use local services, such as data analytics, offered by the mobile network. The mobile network may select network functions that are closer to ED 140, e.g., physically co-located with an AN 102 node that is serving the ED 140.

The network architecture 100 can further comprise a Network Management Function (NMF) 106. The NMF 106 may provide functionalities to manage the life cycle of network functions in the CN 104 and AN 102.

The NMF 106 may communicate with the CN 104 via an M1 interface 108. The NMF 106 may communicate with the AN 102 via an M2 interface 110. The NMF 106 may provide the interface configuration information of C1 interface 146 and C2 interface 148 so that the AN and CN functions can communicate. For example, the NMF 106 may provide one or more address information (e.g., including IP address and port number, fully qualified domain name (FQDN)) of the CN Network-Centric Interface function (NCIF) 112 and CN ED-Centric Interface function (ECIF) 114 to the AN 102 (e.g., to the AN NCIF 116 and AN ECIF 118). Similarly, the NMF 106 may provide one or more addresses (e.g., including IP address and port number) of AN Network-Centric Interface function (NCIF) 116 and AN ED-Centric Interface function (ECIF) 118 to the CN 104 (e.g., to the CN NCIF 112 and CN UCIF 114). Based on the interface configuration information received from the NMF 106, the CN NCIF 112 may allow or authorize one or more of the AN functions to send a message to one or more CN functions via AN NCIF 116 or via AN NCIF 116 and CN NCIF 112. Thus, an AN function may send a message to a CN function directly via the AN NCIF 116 or via the AN NCIF 116 and the CN NCIF 112.

The AN 102 can include one or more of: an AN network service function 120, an AN NCIF 116, an EAIF 122, an AN ECIF 118, an AN ED-centric service function 124, and an AN UP service function 126. The CN 104 can include one or more of: a network function (NF) database 128, a CN NCIF 112, a CN ECIF 114, a CN ED-centric service function 130, a mobile network (MN) service exposure interface 132, a CN UP service function 134, and a network centric service function 136. The CN 104 may provide a logical UP interface C4 152 to provide data connection between the CN 104 and application server in data network 156. The application server 156 may also exchange control information with the CN 104 over the C5 154 logical CP interface, may be via the MN service interface 132.

The AN 102 may have two interfaces with an ED 140, A1C 142, and A1D 144. The A1C interface 142 may carry control messages exchanged between ED 140 and AN 102. The control messages may include messages for one or more of: managing the ED 140 connection with the mobile network, managing data connection between the ED 140 and one or more data networks, and managing the connection between the ED 140 and the network function of one or more mobile networks.

The A1D interface 144 may carry data packets that the ED 140 transmits to or receives from the mobile network and other third-party data networks. The CN 104 may have two interfaces C4 152, and C5 154 with a third-party application server or data network 156.

In the AN 102, an AN network function, such as EAIF 122, may be used to transfer control messages and data with an ED 140. For example, the EAIF 122 may receive a control message, via A1C interface 142, sent from ED 140. EAIF 122 can determine if this message is for managing the data connection between the ED 140 and a data network, or the ED 140 and the mobile network. If control message is for managing the data connection, EAIF 122 can forward the received messages to one or more of AN ED-Centric Service function 124. In some aspects, EAIF 122 may receive the control message sent from the ED 140 and check whether the message is to access services provided by the network. If the control message is to access services provided by the network, EAIF 122 may forward the message to one or more of AN Network-Centric Service functions 120.

In some aspects, a control message received by EAIF 122 may be directed to CN 104. EAIF 122 may directly forward the control message to CN 104, or forward the control message to CN 104 via an appropriate CP interface, such as C1 146 or C2 148 depending on the nature of the control message.

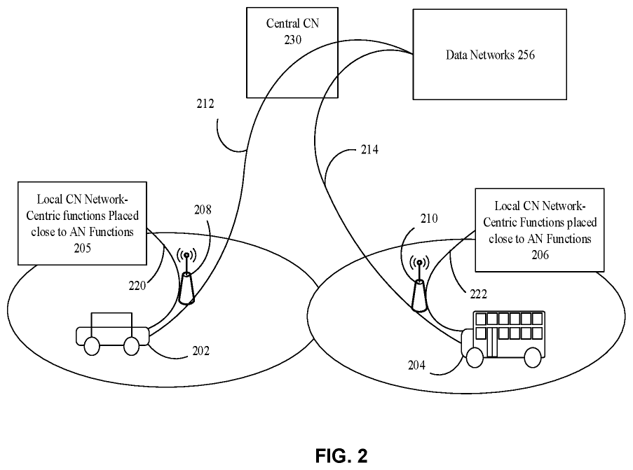

FIG. 2 illustrates an example of a network deployment, according to an aspect of the present disclosure. Network-connected vehicles 202, 204 and EDs of passengers on those vehicles may use services offered by data networks 256, including the internet or services offered by a mobile network operator (MNO).

The MNO may provide local AI/ML services, where a vehicle 202, 204 may send sensory data, such as LIDAR, radar, image, video, vehicle-to-everything (V2X) messaging data 220, 222, to a server installed in the local CN 205, 206, being close to the radio station, 208, 210 of AN. At the same time, the vehicle 202, 204 may send maintenance data 212, 214 to a data server of maintenance center located in the data network 256. The V2X messages may be the messages sent among vehicles, between vehicles and pedestrians, between vehicles and road infrastructure such as road side unit (RSU), between vehicles and mobile network.

By separating the interfaces for CN Network-Centric functions and for CN ED-Centric functions, the AN can forward messages sent between the ED 202, 204 and the local CN functions 205, 206 or central CN functions 230. This separation of interfaces may help reduce packet delay transmission for local services, which may not need to be transmitted to the central CN 230.

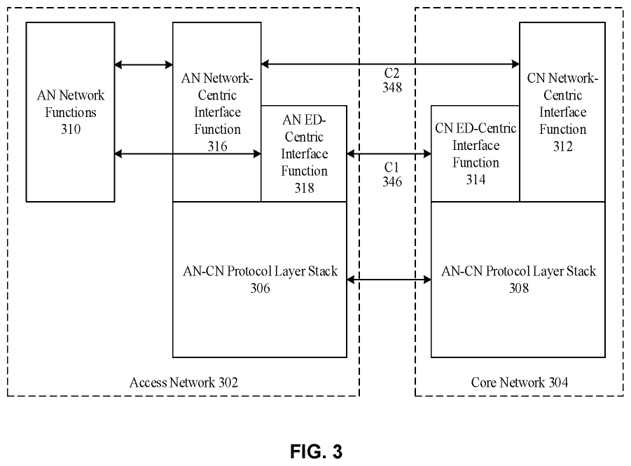

FIG. 3 illustrates a communication protocol between the access network (AN) 302 and the core network (CN) 304, according to an aspect of the present disclosure. Each of the AN 302 and the CN 304 may have an AN-CN protocol layer stack 306, 308, respectively. Generally, the AN 302 may include interface functions 316, 318 which are associated with interfaces 348, 346 with the CN 304. The AN 302 may include one or more AN Network Functions 310. The CN 304 may also include interface functions 312, 314 associated with the interfaces 348, 346 with the AN 302.

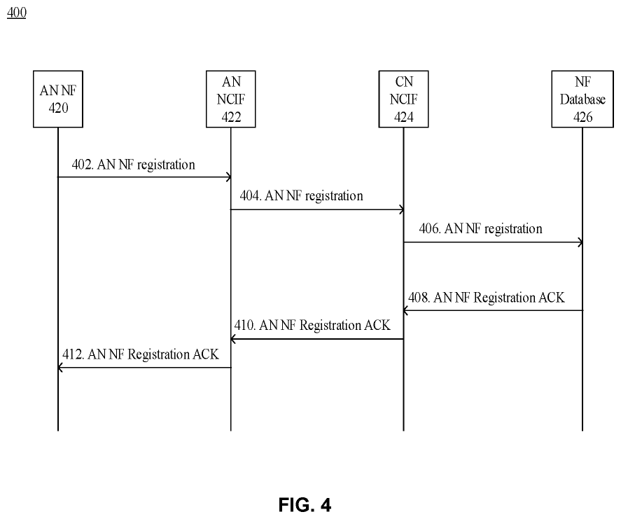

FIG. 4 illustrates a procedure 400 for registering a network function of the access network in the core network, according to an aspect of the present disclosure. The procedure 400 may allow an AN network function 420 register its services in a network function database 426 of a CN. After the AN NF 420 registers its services, other devices and NF in the AN and CN may access services provided by this AN NF 420.

The procedure 400 includes, the AN NF 420 sending an AN NF registration message 402 toward the NF database function 426. The message 402 may include information such as: a Service Request ID-1 to identify the message sent from the AN NF 420, and a NF profile. The NF profile may include one or more of following information: NF name, an address of the AN NF 420 (e.g., IP address, a port number, a FQDN or the like), an AN NF 420 ID, an AN ID, an access technology (AT) type, an AT ID, and a network ID. As illustrated, the message may be sent through one or more of AN NCIF 422 and CN NCIF 424. The AT type may indicate the type of radio access technology, such as 4G, 5G, 6G, WiFi, satellite, or the type of wired access technology, such as optical fiber.

The NF profile included in the message 402 may include one or more of following information: a geographic location which may be represented by a two-dimensional (2D) or three-dimensional (3D) location, a civic address, an AN ID, cell ID. The NF profile may include types of services such as sensory data collection service, type of collected data such as image, video, vehicle-to-everything (V2X) messages, radar, LIDAR, environment data such as temperature, humidity, vehicle and/or non-vehicle traffic counting. The NF profile may include types of AI/ML service, such as federated learning, split learning, supervised learning, unsupervised learning, and reinforcement learning.

If the message 402 is sent through the AN NCIF 422, then then AN NCIF 422 may check whether the AN NF 420 is authorized to register its services. If the AN NCIF 422 determines that the AN NF 420 is authorized to register its services, then the AN NCIF 422 can forward the message received from the AN NF 420 to the NF database function 426, such as forwarding the message via CN NCIF 424.

In some aspects, the AN NCIF 422 can add a Service Request ID-2 to the message 404 to identity that the message 404 that is being sent from the AN NCIF 422. The AN NCIF 422 can store the Service Request ID-1 included in the message received and may not include Service Request ID-1 in the message sent to the CN NCIF 424.

If the AN NCIF 422 sent the AN NF Registration message to the CN NCIF 424, the CN NCIF 424 may check whether the AN NF 422 is authorized to register its services in the NF database function 426. The CN NCIF 424 may use the information received from the AN NCIF 422 to make decision. For example, certain AN ID, or certain AT type, or NF name may be authorized. If the CN NCIF 424 determines that AN NF 422 is authorized to register its services, the CN NCIF 424 may store the Service Request ID-2, and may forward the AN NF Registration message 406 to the NF Database function 426. In some aspects, the Service Request ID-2 may not be sent to the NF Database function 426. The CN NCIF 424 may include a Service Request ID-3 in the AN NF Registration message sent to the NF Database function 426 which may be used to identify this message.

The AN NF information included in the message 406 can be stored in the NF Database function 426 and can be used for discovering and selecting the AN NF 420. The NF Database function 426 may send an AN NF Registration Acknowledgment (ACK) 408, toward the AN NF 420 to confirm that the AN NF 420 is registered in the mobile network or in the CN. The NF database function 426 can send the acknowledgment message 408 to the CN NCIF 424. The message may include the Service Request ID-3 that was sent from the CN NCIF 424.

The CN NCIF 424 can receive the AN NF Registration ACK message 408. The CN NCIF 424 may use Service Request ID-3 to identify the associated AN NCIF 422. The CN NCIF 422 may remove the Service Request ID-3 from the AN NF Registration ACK message 408, and then transmit an AN NF Registration ACK message 410 with Service Request ID-2 to the AN NCIF 422.

Upon receiving the AN NF Registration ACK message 410, the AN NCIF 422 may use Service Request ID-2 to identify the associated AN NF 420. The AN NCIF 422 may remove the Service Request ID-2 from the AN NF Registration ACK message 410 and forward the message together with Service Request ID-1 412 to the AN NF 420. The AN NF 420 may use Service Request ID-1 to determine that its services have been registered in the CN.

As described herein, the network architecture may allow separation of control for device-centric services and network-centric services. Accordingly, deployment of network services can be decoupled from device-centric services. Further, management of ED mobility can be decoupled from the management of network-centric services.

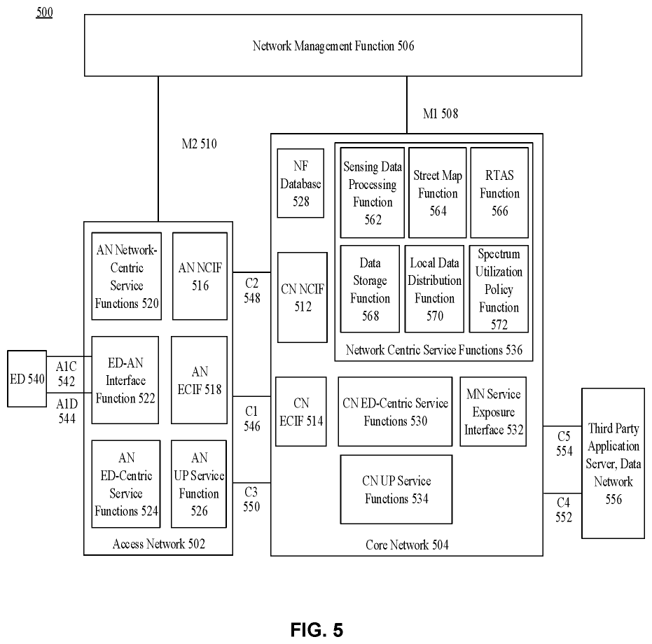

FIG. 5 illustrates the mobile network architecture 500 with additional network functions and services, according to an aspect of the present disclosure. This mobile network architecture 500 is generally similar to mobile network architecture 100, except for the addition of network centric service functions 536.

In an aspect, the network architecture 500 can comprise a NMF 506, which may be similar to NMF 106.

The NMF 506 may communicate with the CN 504 via an M1 interface 508. The NMF 506 may communicate with the AN 502 via an M2 interface 510. The NMF 506 may provide the interface configuration information of C1 interface 546 and C2 interface 548 so that the AN and CN functions can communicate. A third logical interface, C3 550, can be a UP interface for data transfer between the AN and CN. Based on the interface configuration information received from the NMF 506, the CN NCIF 512 may allow or authorize one or more of the AN functions to send a message to one or more CN functions via AN NCIF 516 or via AN NCIF 516 and CN NCIF 512. Thus, an AN function may send a message to a CN function directly via the AN NCIF 516 or via the AN NCIF 516 and the CN NCIF 512.

The AN 502 can include one or more of: an AN network service function 520, an AN NCIF 516, an EAIF 522, an AN ECIF 518, an AN ED-centric service function 524, and an AN UP service function 526. The CN 504 can include one or more of: a network function (NF) database 528, a CN NCIF 512, a CN ECIF 514, a CN ED-centric service function 530, a mobile network (MN) service exposure interface 532, a CN UP service function 534, and one or more network centric service function 536. The CN 504 may provide a logical UP interface C4 552 to provide data connection between the CN 504 and application server in data network 556. The application server may also exchange control information with the CN 504 over the C5 554 logical CP interface, may be via the MN service interface 532.

The AN 502 may have two interfaces with an ED 540, A1C 542, and A1D 544. The A1C interface 542 may carry control messages exchanged between ED 540 and AN 502. The control messages may include messages for one or more of: managing the ED 540 connection with the mobile network, managing data connection between the ED 540 and one or more data networks, and managing the connection between the ED 540 and the network function of one or more mobile networks.

In some aspects, the network centric service functions 536 can include a sensing data processing function (SDPF) 562, a function for street mapping 564, an real-time traffic analytics service (RTAS) function 566, a data storage function 568, a local distribution function 570, and a spectrum utilization policy function 572.

The SDPF 562 may perform one or more functionalities to support the ITS and other applications. For example, the SDPF 562 can estimate the number of non-vehicle users crossing a street, such as pedestrians. The SDPF 562 can further estimate the number of bus passengers waiting at the bus stations, bus stops. The SDPF may be use AI/ML methods to produce traffic statistics in the past and traffic prediction in the future.

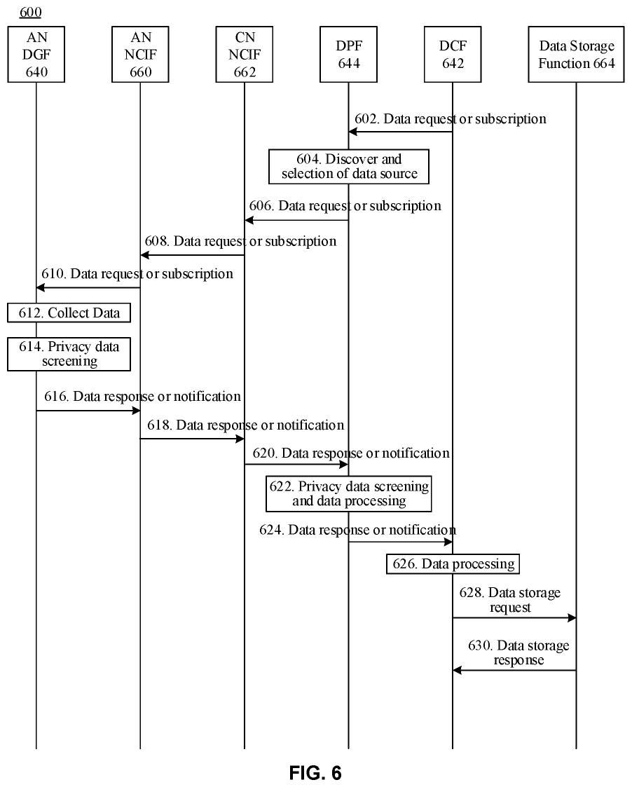

FIG. 6 illustrates a procedure for a function in the CN to receive sensing data from the AN, according to an aspect of the present disclosure. Procedure 600 may provide for a CN to collect sensing data from EDs connected to an AN.

In an aspect, at step 602, a data consumer function (DCF) 642 may send a data request or subscription message to a data processing function (DPF) 644. The DCF 642 may be an RTAS function 566, and the DPF 644 may be an SDPF 502, for example. The message may include one or more of the following information: an NF ID of the DCF, a Service Request ID that identifies the message sent from the DCF, a geographic location to collect data, a type of object to be detected, a type of data, an observation time window, a sampling time duration, and a moving direction of object.

The geographic location included in the data request or subscription message at step 602 may be represented by one or more of geographic areas identified by a geographic area identifier (ID), sensor device ID, names of intersection sections or intersection ID, street (or road, or highway) name of street ID.

The type of object included in the data request or subscription message can be represented by an object ID. The object can be one or more of a vehicle, a truck, a bus, a car, a train, a drone, a bicycle, a motorbike, a pedestrian, or the like. The type of data included in the data request or subscription message may include sensing data. Sensing data may include one or more of location of objects, number of objects in a geographic location, environment information (e.g., temperature, humidity, rain amount, air quality level, and air pollution level), and the like. The observation time window included in the data request or subscription message may be a time period during which data is to be collected. The sampling time duration included in the data request or subscription message can be a time duration in which the number of detected objects is counted. For example, sampling time duration may refer to sensing data including a count of number of passenger vehicles entering a geographic area within a sampling time duration of 5 minutes. The moving direction of an object included in the data request or subscription message can be represented by, e.g., a start geographic location and an end geographic location. In some aspects, if the location is an intersection, the moving direction can be represented by one or more of: the name of the street from which the moving initiates (e.g., the street that starts the moving direction), which may include a corresponding lane number; and the name of the street into which the turn occurs (e.g., the turning street), which may include a corresponding lane number. In some aspects, if the object is one or more pedestrians, the moving direction can be an indication for crossing a street in cast-to-west or west-to-east directions, for example. In some aspects, if the object is a pedestrian, the location can be a bus stop, and the moving direction can be an indication on how many pedestrians can enter a bus.

At step 604, the procedure 600 includes the DPF 644 receiving the message sent from the DCF 642 at step 602. Thereafter, the DPF 644 can discover one or more data sources. For example, the DPF 644 can discover one or more of: network ID, network slice ID, AN ID, AT type, AT ID, NF ID, and ED ID that can provide the requested data, such as sensing data. The DPF 644 may use preconfigured information to discover the one or more of: network, network slice, AN, AT, NF, and ED that can be provide the requested data.

Alternatively, in some aspects, the DPF 644 can send a request message to the NF database function (such as NF database 128) to discover the NF than can provide data. The DPF 644 may include one or more of following information in its request message to the NF Database: the location information, a type of data (such as type of sensing data), an observation window, a network ID, network slice ID, an AN ID, AT type, AT ID and other relevant information.

In response, the NF database function may send a response to the DPF 644 which may include NF information that could be used to select the entity that can provide the requested data. The response from the NF database may include one or more of following information: a network ID, a network slice ID, an AT ID, an AT type, an AN ID, a NF profile, an ED ID (or an ED profile) that can provide sensing data.

The NF profile of the NF or the ED profile that can provide data may include one or more of following information: a network ID, an AN ID, a network slice ID, an AT type, an AT ID, a NF ID for the case of a NF profile, a device ID for the case of ED profile, an address of the NF, a type of data, a location information, and operation hours. The network ID may refer to an identifier that can be used to identify the network, including a mobile network. The AN ID may refer to an identifier of the AN that may provide the requested sensing data. The network slice ID may refer to the network slice ID of the network, or the network slice ID of the AN. The address of the NF may include one or more of following information: IP address, port number, and FQDN. The type of data may refer to a type of sensing data that can be produced. The location information may refer to a location where sensing data may be collected. The operation hours may refer to a time window during which the sensing data can be produced. The operation hours can be represented by a start time and an end time, and each of the start time and end time can be indicated e.g., in terms of hours, minutes and seconds of a certain day. In some aspects, the operation hours can be an interval indicated by a start time and an end time, where each of the start time and the end can be indicated in terms of hours, minutes and seconds and a corresponding year, month and date.

Based on the information included in the message at 602, the DPF 644 can select one or more data sources. For example, DPF can select one or more of: network, AN, AT, NF, and ED that can provide the requested data. In an aspect, the DPF 644 can select a data source having an ID, such as AN IDI, for providing radar sensing data, such as to detect vehicle objects or passengers. The DPF 644 can further select a data source for providing LIDAR sensing data that can be used to detect whether the object is a passenger vehicle, or a bus, or a truck, or a pedestrian. The DPF 644 can further select a data source for providing location information of mobile devices. The AN ID4 may provide video data, or photo data, or V2X messages.

After identifying the one or more network, AN, AT, NF, ED that can provide relevant sensing data, at step 606, the DPF 644 may send a message to the identified AN or NF directly, or via one or more of the AN NCIF 660 and the CN NCIF 662 to request data or subscribe for sensing data. The data request or subscription message may include one or more of the following information: a Network ID, an AN ID, a network slice ID, a NF ID of AN Data Generation function (DGF), an NF ID of the DPF that requests the sensing data, an ED ID, an ED location, a CN ID, a network slice ID of the CN, a service request ID, a type of sensing data, location information, and other information that may be the same or subset of information received in the message at step 602.

The AN ID may be an identifier of the AN which may provide the requested sensing data. The NF ID may be an identifier of NF in the AN which may provide the requested sensing data. The ED ID may be an ID of ED that may provide the requested sensing data The ED location may refer to a location of the ED, such as AN node ID, AN cell ID. The CN ID may be an identifier of the CN that the DPF belongs to. The network slice ID of the CN may be the network slice ID of the DPF. The service Request ID may be an identifier that identifies the data request or subscription message. The type of sensing data can include one or more of the following sensing data: LIDAR, radar, photo, video, V2X messages, and/or location information. In some aspects, the location information can be one or more of: a 2D, 3D location, an indication of a distance to a point (e.g., a location of a radio equipment such as antenna), a bounding box, and azimuth and altitude angles.

The location information can be the same as or a subset of the location information received in the message at step 602. In some aspects, the AN can provide data for an area that is smaller than the location indicated in the message at step 602, then in such aspects, the DPF 644 can include location information that identifies an area that is smaller than the geographic area indicated in the message at step 602.

If the CN NCIF 662 receives the data request or subscription message sent from the DPF 644 at 606, the CN NCIF 662 can check whether the CN or the CN DPF 644, or both, are authorized to send the message to the AN. If CN NCIF 662 determines that the DPF, the CN or both are authorized, the CN NCIF 662 can send a data request or subscription message to one or more data sources that can provide the requested sensing data. The CN NCIF 662 can send the message directly to the one or more data sources (e.g., NF in the AN), or via the AN NCIF 660 corresponding to the AN ID received at step 606. The CN NCIF 662 may include its NF ID in step 608.

If the AN NCIF 660 receives the message sent from the DPF 644 at 606 or from the CN NCIF 662 at step 608, the AN NCIF 660 may check whether the CN or the DPF 644, or both, are authorized to send the sensing data request or subscription message to the AN. If the CN or the DPF 644, or both, are authorized to send the data request or subscription, at step 610, the AN NCIF 660 can send a Sensing Data Request or Subscription to the AN Data Generation function (DGF) 640, such as Sensing Data Generation function (SDGF) corresponding to one or more of following information received from the DPF, e.g., AN ID, ED location, AN DGF ID, received in step 606.

At step 612, the AN DGF 640 receives the data request or subscription message from the AN NCIF 660 or from the CN NCIF 662. In some aspects, the AN DGF 640 may request from one or more sensors, such as photo cameras, video cameras, radar, LIDAR, V2X message receiver to collect and provide requested sensor data, including sensing data for the location of interest. The one or more sensors may be installed in fixed locations or any appropriate location such as a light pole, a radio tower, a wall, a rooftop of building, or even in a mobile item such as a vehicle.

In some aspects, if the ED ID is provided in the data request or subscription message, the AN DFG 640 can send the data request or subscription message to the ED via an EAIF. The EAIF may identify the ED location, such as the serving AN node, in order to forward the data request or subscription message to the ED.

In some aspects, if the data request or subscription message indicates a location of interest where sensing data is to be collected by an ED, such as a mobile data source (e.g., a LIDAR device installed in a vehicle), then, when the ED enters a location of interest, such as an interaction, the AN DGF 640 may request the ED to collect the sensing data. The AN DGF 640 may be aware of one or more mobile sensor devices that are currently located in the location of interest. The AN DGF 640 can send a request via the EAIF if the mobile sensor uses wireless connection to communicate with the network.

After collecting the requested data, such as sensing data, at step 614, the AN DGF 640 can process the data to perform one or more of the following operations: remove irrelevant information, protect data privacy (e.g., via anonymizing data or other techniques used to maintain or protecting privacy), compress the data (e.g. compressing raw images or raw video data), and maintain or improve data security. For example, if the requested sensing data indicate LIDAR data for counting the passenger vehicles, after collecting such data, the AN DGF 640 can remove information identifying the type of vehicle (e.g., a minivan or a sedan). In another example, the AN DGF 640 can remove the vehicle color and mask the number plate from one or more of video and photo cameras.

At step 616, the AN DGF 640 can send a data response or notification including the collected data to the DPF 644 directly, or via one or more of the AN NCIF 660 and the CN NCIF 662. The AN DGF 640 may include in the data response or notification one or more of following information: the service request ID that was sent from DPF at step 606, a time stamp of the sensing data, an AN ID, an AT type, an AT ID, an AN node ID, an AN cell ID, an AN DGF ID, a network ID, a network slice ID, a CN ID, an ED ID, a location ID, location information, a type of data, data, and parameters to read the data.

The ED ID in the data response or notification may refer to an identifier that may be used to identify the ED, such as the sensing device that provides the data. The location ID in the data response or notification can indicates the geographic location from where the data is taken or where the taken data is associated with. The location information may contain AN cell ID, civic address, 2D or 3D geographic locations. The type of data in the data response or notification can refer to one or more of: LIDAR, radar, image, video data, V2X messages, or the like. The data in the data response or notification can refer to the data that was requested by the DPF 644.

If the AN NCIF 660 receives the data response or notification message, at step 618, based on the one of the received information elements, including the Service Request ID, the CN ID, the DPF ID, the AN NCIF 660 can identify one or both of the CN NCIF 662 and the DPF 642 that requested the data. Thereafter, the AN NCIF 662 can send the service request ID and one or more information received from the AN DGF 640 at step 616 to the DPF 644 directly or via the CN NCIF 662.

If the CN NCIF 662 receives the data response or notification message from the AN NCIF 660, based on one or more information elements received, including the Service Request ID, the CN ID, the DPF ID, the CN NCIF 662 can, at step 620 identify the DPF 642 that requested the sensing data. Thereafter, the CN NCIF 662 can send one or more of following information to the DPF 642: the service request ID and one or more information received from the AN DGF 640.

At step 622, the DPF 644 can receive some or all of the collected sensing data from one or more of: AN, AN DGF 640, AN NCIF 660, CN NCIF 662. The DPF 644 can process the collected data to produce the information requested in the data request or subscription received at step 602. The DPF 644 can remove information such as identifying information to protect privacy. Some examples of identifying information include human faces in images and video data, number plates of vehicles, etc. The DPF 644 can store, in a data storage function, the collected data received at 620. The DPF can also store the processed data to the data storage function.

For sensing purposes, in some aspects, the DPF 644 can use data from different sensing sources to detect one or more objects. For example, the DPF 644 can use: LIDAR and radar signal to detect vehicle objects, and use photo data and LIDAR to detect a human.

In response to the data request or subscription message received at step 602, at step 624, the DPF 644 can send one or more data response or notification messages to the DCF 642 (e.g., RTAS function 506). The one or more data response or notification can include data, e.g., the ED Location Response or ED Location Notification.

At step 626, the DCF 642 can receive the data included in one or more data response or notification messages. The DCF 642 can perform data analysis on the received data, using mathematical tools, like AI and ML, to derive desired information. The desired information may include one or more of statistics in the past and prediction in the future of, e.g., vehicle traffic patterns, pedestrian traffic patterns, bus or underground passenger patterns and the like. Each of the desired pattern information may be associated with one or more of: a targeted time or time window and a geographic location.

At step 628, the DCF 642 can send the processed sensing data and the derived analytics data to a data storage function 664. At step 630, the data storage function 664 may send a response message to the DCF 642 to acknowledge the received message at step 628. The response message can indicate one or more of whether data has been received and whether data has been stored successfully or not.

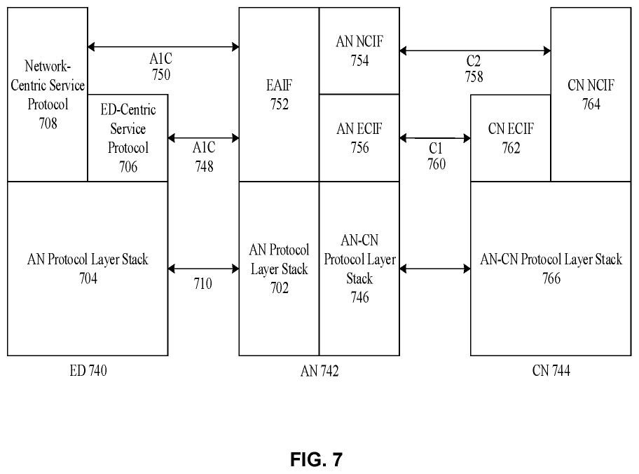

FIG. 7 illustrates a communication protocol between an ED and the mobile network, according to an aspect of the present disclosure. The ED 740 can include an AN protocol layer stack 704, a network-centric service protocol 708, and an ED-centric service protocol 706. The AN 742 can include an AN-CN protocol layer stack 746 and a AN protocol layer stack 702. Each of the network-centric service protocol 708 and the ED-Centric service protocol 706 can have an A1C interface 748, 750 with the AN 742 (via the EAIF 752).

In some aspects, the AN 742 can further include an AN NCIF 754 and an AN ECIF 756. In some aspects, the CN 744 includes an AN-CN protocol Layer stack 766, a CN NCIF 764, and a CN ECIF 762. The AN 742 may have one or more interfaces C1 760 and C2 758 with the CN 744. As illustrated the C1 760 interface may be between the AN ECIF 756 and the CN ECIF 762, and the C2 758 interface may be between the An NCIF 754 and the CN NCIF 764.

In an aspect, when an application in an ED 740 wants to access a service provided by the mobile network, the application can generate a service request or a service subscription message and send to the network-centric service protocol (NCSP) unit 708 of the ED 740. The service request or subscription message can include one or more of the following information: an application ID to identify the application, a service request ID, an ED ID, an address of the application server in the mobile network, a service ID, data to be analyzed, a time stamp, a deadline, a type of network information, a service location, a data time window, and a subscription time window.

The application ID in the Service Request or subscription message may identify the application. The Service Request ID in the Service Request or subscription message can identify the transaction between the ED and the mobile network. The ED ID in the Service Request or subscription message may refer to an ID to identify the device, e.g., temporary mobile Temporary Mobile Subscriber Identity (TMSI), Subscription Concealed Identifier (SUCI), Subscription Permanent Identifier (SUPI) or the like.

The address of the application server in the mobile network can include one or more of following: an IP address or IP prefix, an associated port number, and FQDN. The Service ID in the Service Request or subscription message can identify the type of service: e.g., data analytics service (e.g. statistics in the past or prediction in the future), network information request, etc. The data to be analyzed may be related to the type of service requested. For example, if the ED requests a data analysis service of the mobile network, such as to detect objects in one or more of: a photo, a video, a LIDAR data file, and a radar data file, the ED can send the data file in the Service Request or Subscription message. The time stamp in the Service Request or subscription message can indicate the time the Service Request or Subscription message is created.

The deadline in the Service Request or subscription message can indicate the time the ED expects to receive a response from the service provider function (SPF). In some aspects, the deadline can indicate an absolute time, such as in the format year-month-date hour-minute-second-millisecond. In some aspects the deadline can indicate a relative time from the time stamp, such as indicating how long after (in hours, minutes, seconds or milliseconds) the time stamp the ED expects to receive the response from the SPF.

The type of network information can include analytics information, such as including one or more of: statistics and prediction of traffic density. The type of network information can be represented by one or more of: a network information ID and analytics information ID.

The service location included in the service request or subscription message can refer to the location wherefrom the network information is requested. The data time window can refer to a time window during which the relevant data can be collected to produce data statistics in the past or data prediction in the future. The data time window can be represented by a start time and an end time, where the time may include one of more of: year, month, date, hour, minute, second, millisecond.

The subscription time window can refer to the time period during which the ED needs the network service. The subscription time window can be represented by a start time and end time, where the time may include one of more of year, month, date, hour, minute, seconds.

In an aspect, the NCSP 708 can read the service request or subscription message and send the message to the AN Protocol Layer Stack 704 in the ED 740. The AN Layer protocol layer stack 704 in the ED 740 can forward the service request or subscription message to the AN Protocol Layer Stack 702 in the AN 742 via a wireless or wired physical medium 710. The wireless or wired physical medium 710 may be channel (or a physical channel in the case of wired physical medium) that carries the control message. The AN Protocol Layer Stack 702 can further forward the ED service request or subscription to the EAIF 752 in the AN 742. The EAIF 752 can read the ED service request or subscription message and use the information provided in the message to forward the message to a service provider function (SPF) in the CN 744 directly, or via one or more of: the AN NCIF 754 and via the CN NCIF 764.

In some aspects, the MNO can provide real-time services, such as road traffic information, to the ED 740.

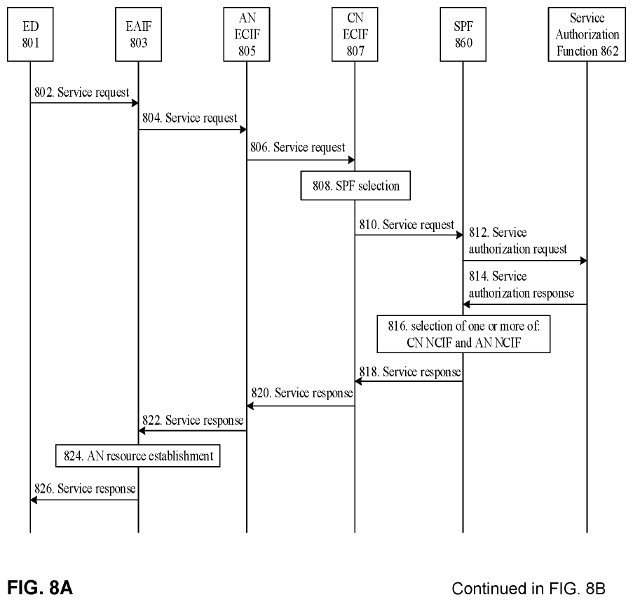

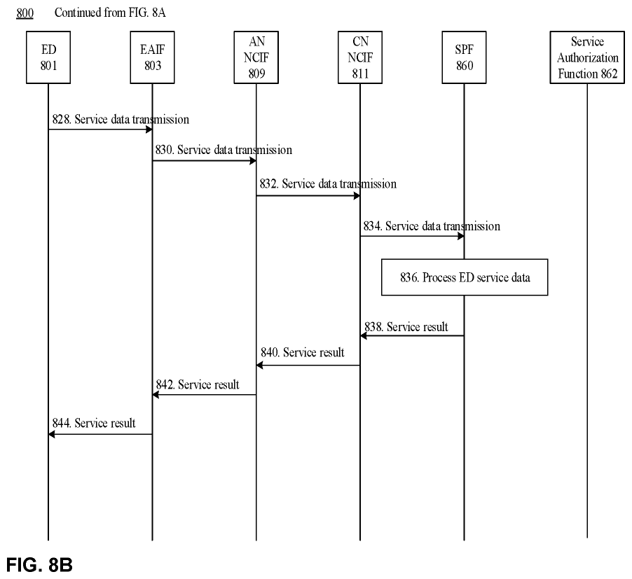

FIGS. 8A & 8B illustrate a procedure for an ED 801 to obtain a real-time service from the mobile network, according to an aspect of the present disclosure. The procedure 800 may provide for a user device, such as ED 801, to obtain, for example, local sensing information and AI/ML services.

At step 802, the procedure 800 includes an ED 801 may receive a control message from an application in the application layer of the user device. The ED 801 can read the control message, for example, the ED 801 can read one or more of the header of the control message, Application ID carried in the message, the IP address, and a port number of the destination server. In an aspect, the control message can be a request for a service provided by the mobile network. For example, the control message can carry an indication, such as an MNO MEC Service Request, that indicates the message is to request a service, such as MEC service, provided by the mobile network.

In some aspects, the ED 801 can request a data analytic service such as a service to obtain real-time vehicle and non-vehicle traffic density updates.

In some aspects, the ED 801 can be a device in an autonomous vehicle, and the request can be a request for a service to detect one or more objects in a sensory data file, such as image, video, LIDAR or radar signal collected from the environment surrounding the vehicle. The ED 801 can send a service request or service subscription in a control message and sends this control message in a control channel between the ED 801 and the AN node. The control channel may be carried by a wireless or a wired medium.

The service request or service subscription can include one or more of the following information: an ED ID, an ED location, an Application ID, a Service ID, a Destination information, a Data Network Name (DNN), a Network slice ID, a location of the requested service, and data to be analyzed by the mobile network service.

The ED location can be one or more of a 2D or a 3D GPS location, an AN node ID, and a cell ID. The Application ID can be an ID for identifying the application request by the ED 801. The Service ID can be an ID for identifying the service provided by the mobile network. The Destination information can be represented by an IP address and port number of the server in the mobile network or the external network. The location of the requested service can include one or more of: a geographic zone ID, a road segment ID, an AN node ID, a cell ID, or the like. The data to be analyzed by the mobile network service can include one or more of: a LIDAR data, a radar data, an image, a video and the like.

In an aspect, the ED 801 can send a service request, for example, an RTAS Request or an RTAS Subscription message, to the mobile network to get the service (e.g., service for road traffic analytics information). The Service Request can be sent over the control channel A1C from the ED to the EAIF.

In an aspect, if the ED 801 sends an RTAS Request, the ED 801 may want to receive and thus request to receive the road traffic analytics information one time (e.g., in one response, in one transmission or a one continuous transmission). In some aspects, if the ED 801 sends an RTAS Subscription, the ED 801 may want to receive and thus request to receive the road traffic analytics information multiple times.

The RTAS Request or RTAS Subscription may include one or more of following information: a travel path between two points, a location, a waypoint, an accuracy of the road analytics information requested, a type of road analytic information, and an indication to receive RTA updates.

The travel paths between two points can be indicated by a starting point and an end point. The travel path can include one or more of: a starting point, an ending point, and a list of waypoints. Each point can be represented by a point in 2-dimensional (2D) or 3-dimensional (3D) coordinate, or could be the list of intersections. Each point of the travel path can be associated with a time or a time window that the ED 801 may arrive at, leave, or stay.

The location can be associated with a time window, which can be represented by a start time and an end time. The time can be described in terms of one or more of: year, month, date, hour, minute, second, e.g., 2021-10-10 10-10-10. The accuracy of the road analytics information can be indicated by a percentage (e.g., 90% accuracy) or other indications.

The type of road analytics information can include the number of vehicles travelling in a road segment (or between two waypoints) in an observation window. The observation window can be represented by a start time and an end time.

The type of road analytics information can further include the vehicle traffic density of a road segment between two points. In some aspects, the vehicle traffic density can be measured by the number of vehicles entering a road segment, divided by the length of an observation time. In some aspects, the vehicle traffic density can be measured by the number of vehicles entering a road segment, divided by the length of observation time, divided by the number of lanes in the travel direction, divided by the length of the road segment. A person skilled in the art may appreciate that there are other appropriate methods of measuring the vehicle traffic density.

The type of road analytics information can further include the non-vehicle traffic density. The non-vehicle traffic density can be measured by the number of non-vehicle road users entering a road segment, divided by the observation window (or observation period). The non-vehicle road users can include one or more of: cyclists, motorists, pedestrians, or any other road users.

The type of road analytics information can further include the number of pedestrians crossing one or more roads at an intersection. The intersection can be at one or more starting points or one or more ending points of one or more road segments. In some aspects, the intersection can be between a starting point and an ending point of a road segment.

In some aspects, the indication to receive RTA updates can be omitted if the ED 801 sends the RTAS Subscription message.

At step 804, the EAIF 803 can receive the Service Request from the ED 801. The EAIF can forward the Service Request message to the AN ECIF 805 or the CN ECIF 807. If the AN ECIF 805 receives the service request message at step 804, then at step 806, the AN ECIF 805 may forward the Service Request message to the CN ECIF 807.

At step 808, the CN ECIF 807 can receive the Service Request from the ED 801. The CN EICF 807 can read the Service Request message. The CN EICF 807 can use one or more of information carried in the Service Request message to discover and select an SPF function 860 to serve the ED request.

In some aspects, the CN ECIF 807 can send a request to the NF Database (such as NF database 128) to discover the SPF. The CN ECIF 807 can include in the request to the NF database one or more of following pieces of information: an ED ID, an ED location, an Application ID, a Service ID, a Destination information, a DNN, a Network slice ID, a location of the requested service. The NF Database can respond to the CN ECIF 807 with a response message including information on the SPF 860. The response message can include information indicating a NF profile of the SPF 860 that may provide the requested services. The CN ECIF 807 can then select the SPF from the information of SPF received from the NF Database.

In some aspects, the CN ECIF 807 can have pre-configured information about the SPF, e.g., one or more NF profile(s) of the SPF stored in the CN ECIF 807. The CN ECIF 807 can select a SPF by using preconfigured information.

The CN ECIF 807 can store the SPF information that is selected to serve the ED Service Request. The SPF information can include one or more of: a NF ID of the SPF, an ED ID, a Service ID, an Application ID, an ED Location and other relevant information

At step 810, the CN ECIF 807 can forward the Service Request to the selected SPF 860.

At step 812, the SPF 860 can receive the Service Request message from the ED 801 via the CN ECIF 807. The SPF 860 can then send a Service Authorization Request message to a service authorization function 862 to check whether the ED 801 is authorized to use the service requested. The SPF 860 can include in the service authorization request message one or more information elements received from the service request message.

At step 814, the Service Authorization Function 862 can determine whether the ED 801 is authorized to use the requested service(s) based on one or more of: the ED data (such as ED profile, ED subscription services), and information received from the SPF. The Service Authorization Function 862 can send a Service Authorization Response message to the SPF 860. The Service Authorization Response message can indicate whether the ED 801 is allowed to use the requested service(s) or not. If the ED 801 is allowed to use the requested service, the Service Authorization Function 862 can include in the Service Authorization Response message one or more of: a location where the ED 801 can use the service, a time window the ED 801 may use the service. If the ED 801 is not allowed to use the request service(s), the Service Authorization Function may send a cause that the requested service(s) is rejected.

If the ED 801 is authorized to use the requested service(s), at step 816, the SPF 860 may select one or more interface functions (such as a CN NCIF 811 and an AN NCIF 809) to communicate with the AN and the ED 801.

In some aspects, the SPF 860 can send a request to the NF Database function to discover one or more available interface functions (e.g., CN NCIF 811 and an AN NCIF 809). The request message can include one or more of following information: an ED ID, an ED Location, a Service ID, an Application ID, a Service Location, an SPF NF ID, a DNN, a Network Slice ID, an AN ID, a cell ID, an AT type, and an AT ID. The NF Database function can send a response message to the SPF 860. The response message can include one or more NF profiles of one or more of: a CN NCIF 811 and an AN NCIF 809.

At step 818, the SPF 860 can send a Service Response message towards the ED 801. In some aspects, the SPF 860 can send the Service Response message to the ED 801 via the EAIF 803. In some aspects, the SPF 860 can send the Service Response message to the ED via one or more of: the CN ECIF 807 and the AN ECIF 805.

In the service response, the SPF 860 can include one or more of the following information: an ED ID, an ED Location, a Service Accept or a Service Reject indication, a cause for Service Reject (in case the requested service is rejected), a Service Location for the accepted service, a Time Window for the accepted service, a NF ID of the SPF, an Address information of the SPF (e.g. an IP address and a port number, a FQDN), a Service ID, an Application ID, a DNN, a Network Slice information, a NF ID of the selected CN NCIF, a NF ID of the selected AN NCIF, and a EAIF NF ID.

In some aspects, the SPF can include in the Service Response two messages: a Network-Centric (NC) Service Response message to be sent to the EAIF 803, and an ED Service Response message to be sent to the ED 801.

In some aspects, the NC Service Response message may include one or more of the following information: an ED ID, an ED Location, a Service Location for the accepted service, a Time Window for the accepted service, a NF ID of the SPF, an Address information of the SPF (e.g., an IP address and a port number), a Service ID, an Application ID, a DNN, a Network Slice information, a NF ID of the selected CN NCIF 811, a NF ID of the selected AN NCIF 809, and a EAIF NF ID.

In some aspects, the ED Service Response message may include one or more of the following information: an ED ID, a Service Accept or a Service Reject indication, a cause for Service Reject (in case the requested service is rejected), a Service Location for the accepted service, a Time Window for the accepted service, a NF ID of the SPF, an Address information of the SPF (e.g., an IP address and a port number), a Service ID, an Application ID, a DNN, and a Network Slice information.

If the CN ECIF 807 receives the Service Response message from the SPF 860, at step 820, the CN ECIF 807 can forward the Service Response message towards the EAIF 803 directly or via the AN ECIF 805.

If the AN ECIF 805 receives the Service Response message from the SPF 860, at step 822, the AN ECIF 805 can forward the Service Response message to the EAIF 803.

At step 824, the EAIF 803 can receive the Service Response message from the SPF 860 directly or via one or more of the AN ECIF 805 and the CN ECIF 807. In some aspects, if the SPF 860 sent the NC Service Response message to the EAIF 803, the EAIF 803 can store one or more of information elements of the NC Service Response message into an ED Service Profile of a local memory accessible by the EAIF 803. The ED Service Profile can include one or more of the following information: an ED ID, an ED Location, a Service Location for the accepted service, a Time Window for the accepted service, a NF ID of the SPF 860, an Address information of the SPF 860 (e.g., an IP address and a port number), a Service ID, an Application ID, a DNN, a Network Slice information, a NF ID of the selected CN NCIF, a NF ID of the selected AN NCIF, and a EAIF NF ID.

In some aspects, the EAIF 803 can assign AN resource to serve the data transmission between the ED 801 and SPF 860. For example, the AN 102 can assign a radio service channel between the ED 801 and AN 102 to transfer messages between the ED 801 and SPF 860.

At step 826, the EAIF 803 can forward the ED Service Response message received from the SPF 860 to the ED 801. In an aspect, if the ED Service Response message includes a Service Rejection indication, the ED may not send a Service Data Transmission at step 828 (referring to FIG. 8B) and operations at steps 830 to 844 are not performed.

If the ED Service Response message includes a Service Accept indication, at step 828, the ED 801 can send a Service Data Transmission message to the EAIF 803, towards the SPF 860.

In an aspect, the ED 801 may receive from an application in the application layer of the user device a message. The ED 801 can read the message, for example, the ED 801 can read one or more of: the header of the message, Application ID carried in the message, the address information (e.g. IP address, port number, FQDN) of the destination server (e.g., SPF). In some aspects, the message can be sent to an SPF in the mobile network. For example, the message can carry an indication, e.g., MNO MEC Service Data that indicates the message is to be sent to, e.g., a MEC service, provided by the mobile network. The ED 801 can request a data analytic service such as a service to obtain real-time vehicle and non-vehicle traffic density updates.

In some aspects, the ED 801 can be a device in an autonomous vehicle, in which the ED 801 can request a service to detect one or more objects in a LIDAR or radar data collected from the road.

In some aspects, the service data transmission message at step 828 can include one or more of the following information: a destination information, a DNN, a network slice ID, and a service container message.

The destination information can include information related to the SPF 860. For example, the destination information can include one or more of the following information: a network ID, an address of the SPF (e.g., an IP address and a port number of the server), and a FQDN of the SPF.

The Service Container message can include one or more of following information: an ED ID, a destination information, a service request ID, an ED location, an Application ID, a service ID, a location of the requested service, data to be analyzed or collected by the SPF of the mobile network, and attributes of the data.

The ED ID can be an ID for identifying the device, such as one or more of: a sensor device ID, and a temporary mobile subscriber ID (TMSI). The service request ID can be an ID for identifying the service request that sent from the ED 801. The ED location can include one or more of: a 2D or a 3D GPS location, a network ID, an AT type, an AT ID, an AN ID, an AN node ID, and a cell ID. The Application ID can be an ID to identify the application request by the ED 801. The Service ID can be ID to identify the service provided by the network. The location of the requested service can include one or more of: a geographic zone ID, a road segment ID, a network ID, an AT type, an AT ID, an AN ID, an AN node ID, and a cell ID.

The data to be analyzed or to be collected by the SPF 860 can include one or more of: a LIDAR data, a radar data, an image, a video, V2X messages, and any sensing data that is to be analyzed. In some aspects, the ED can provide sensing data to the SPF 860. The sensing data can include one or more of: LIDAR data of a road surface, a radar data of a road surface, an image of a highway, a video of a highway, and environmental data (e.g., temperature, rain volume, humidity level, and air quality level), and any sensing data.

The attributes of data can refer to attributes of the sensing data. For example, the sensing data can have one or more of the following attributes: a location of device where the sensing data is collected (e.g., a 2D or a 3D GPS location), a timestamp of the data (which can indicate the time the data is created or collected).

At step 830, the EAIF 803 can receive the Service Data Transmission message from the ED 801. The EAIF 803 can check the ED Service Profile, and can read the information carried in the Service Data Transmission message to determine the destination of the message. For example, the EAIF 803 can read one or more of: the Service ID, the Application ID, and the Destination Information. If the ED Service Profile includes the destination information received from the SPF, the EAIF 803 can forward the Service Data Transmission message to the SPF 860 directly, or via the one or more of: the AN NCIF 809 and the CN NCIF 811.

In some aspects, if the EAIF 803 forwards the Service Data Transmission message to the AN NCIF 809, the EAIF 803 can include the CN NCIF address information (such as one or more of: the NCIF NF ID, the corresponding IP address and port number) in the message.

If the AN NCIF 809 receives the Service Data Transmission message from the EAIF 803, at step 832, the AN NCIF 809 can send the Service Data Transmission message to the SPF 860 directly, or via the AN NCIF 809.

If the CN NCIF 807 receives the Service Data Transmission message from the EAIF 803 or the AN NCIF 809, at step 834, the CN NCIF 807 can send the Service Data Transmission message to the SPF 860. At step 836, the SPF 860 can receive the service data sent from the ED 801.

In some aspects, if the ED 801 requests a data analysis, the SPF 860 can use an AI/ML method to analyze the data. For example, the ED 801 can request a service for detecting one or more objects in one or more of: a LIDAR data, a radar data, a video, and an image. The SPF can use one or more processing techniques to detect the one or more objects.

In some aspects, if the ED 801 provides the data, the SPF 860 can store the data in a database function. For example, the ED 801 can provide data related to one or more of: an update of a road surface, environmental data (e.g., temperature, wind speed, rain volume),

After processing the service data, at step 838, The SPF 860 may send a Service Result towards the ED 801. The Service Result message may be sent to the EAIF 803 directly, or via one or more of: the CN NCIF 811 and the AN NCIF 809. The Service Result message may include one or more of following information: a Destination Information, an ED ID, and an ED container message.

The Destination Information can include one or more of following information of the EAIF 803: a NF ID of the EAIF 803, an address of the EAIF (e.g., an IP address and a port number), a FQDN of EAFI, and a Network ID of the EAIF 803 (to identify the network of the EAIF 803), an AN ID of the EAIF 803.

The ED Container message can include one or more of following information to be sent to the ED 801: an ED ID, a Service Request ID, a Service Acknowledgement, a list of detected objects and their corresponding attributes, an accuracy of the object detection, a Timestamp of the Service Result.

The Service Request ID included in the ED Container message can be the same as the Service Request ID sent from the ED 801 at step 828. The Service Acknowledgement can indicate that the service request has been fulfilled.

The list of detected objects and their corresponding attributes can include one or more of: an object description (e.g., human, vehicle, pedestrian, cyclist, motorist, car, and truck), an object size description, a location of object (e.g., absolution 2D or 3D location in a map, a bounding box surrounding the detected object with location description), a 2D or a 3D relative distance to the ED 801.

The accuracy of the object detection can be one or more of: a percentage in terms of accuracy (e.g., 80% accuracy), a percentage of inaccuracy (e.g., 20% inaccuracy), a percentage of reliability (e.g., 80% reliability) and other methods or techniques for indicating an accuracy of the object detection. The Timestamp of the Service Result can indicate one or more of: the time the service request is fulfilled, the time the service result is sent from the SPF 860, or the time the object is detected by the SPF 860, the timestamp of the data that was included in the message 828.

If the CN NCIF 811 receives the Service Result message from the SPF 860, at step 840, the CN NCIF 811 can check the destination information to forward the message to. For example, the CN NCIF 811 can forward the Service Result message to the EAIF 803 directly, or via the AN NCIF 809.

If the AN NCIF 809 receives the Service Result message, at step 842, the AN NCIF 809 can check the destination information to identify the EAIF 803. Thereafter, the AN NCIF 809 can forward the Service Result message to the EAIF 803.

At step 844, the EAIF 803 can receive the Service Result message from the SPF 860. The EAIF 803 can check the ED ID to identify the ED to send the message to. Thereafter, the EAIF 803 can forward the ED Container message to the ED 801.

Aspects described herein may allow a user device to discover and request a service of the network. In some aspects, the ED service request can be recognized by the EAIF 803, and the EAIF 803 can direct the message to the CN function that provide the service. In comparison to 5G, all ED control messages are forwarded from the AN to the CN via the AMF, which does not allow for separation of mobility management from service management.

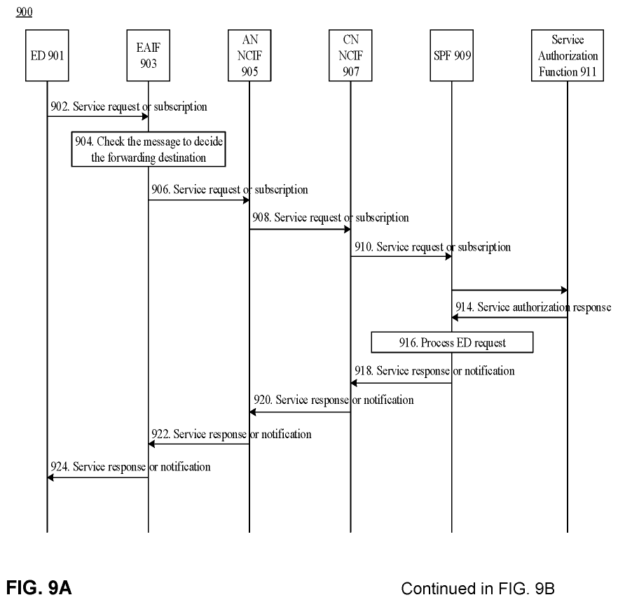

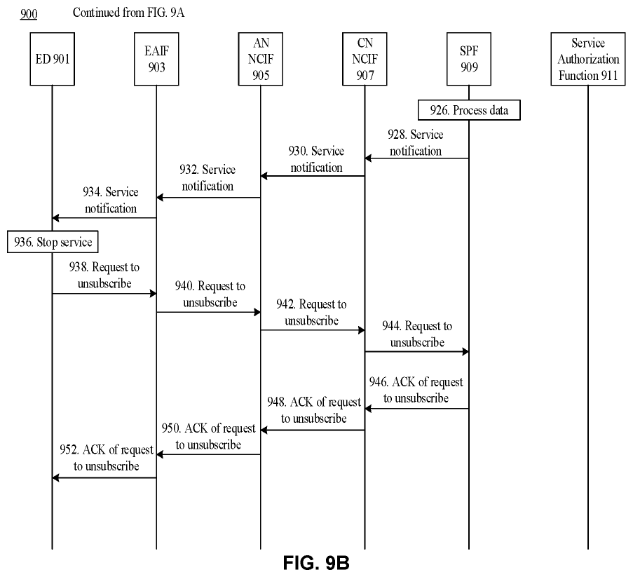

FIGS. 9A & 9B illustrate a procedure for an ED 901 to obtain a service from the mobile network, according to an aspect of the present disclosure. The procedure 900 allows an ED 901 to obtain sensing information and AI/ML services from the mobile network. In some aspects, the procedure 900 can permit an ED 901 to obtain real-time service or data information from the mobile network by communicating with a SPF (e.g. RTAS function) via a CP interface.

According to an aspect, at step 902, the ED 901 can receive from an application in the application layer of the user device a control message. The ED 901 can read the control message. For example, the ED 901 can read one or more of: the header of the control message, an Application ID carried in the message, an IP address of the destination service, and a port number of the destination server.

In some aspects, the control message can carry an indication, such as an MNO MEC Service Request that indicates the control message is to request a service, e.g., a MEC service, provided by the mobile network. The ED 901 can request a data analytic service such as a service for obtaining real-time vehicle and non-vehicle traffic density updates.

In some aspects, the ED 901 can be a device in an autonomous vehicle, and the request can be a request for a service to detect one or more objects in a LIDAR, radar signal, image, video, or V2X messages collected from a road. For example, the ED 901 can send a Service Request or Service Subscription in a control message and send this control message in a control channel between the ED 901 and the AN node. The control channel can be carried by wireless or wired medium. For example, ED 901 can send the control message comprising the service request or subscription to the EAIF 903.

The Service Request or subscription can include one or more of the following information: an ED ID, an ED location, an Application ID, a Service ID, a destination information, a DNN, a network slice ID, a location of the requested service, data to be analyzed by the mobile network service, a time stamp and a deadline.

The ED 901 location can be one or more of: a 2D or a 3D GPS location, an AN node ID, and a cell ID. The Application ID can be an ID to identify the application request by the ED 901. The Service ID can be an ID to identify the service provided by the network. The destination information can be represented by the IP address and the port number, or FQDN of the server in the mobile network or the external network.

The location of the requested service can include one or more of: a geographic zone ID, a road segment ID, an AN node ID, a cell ID. The data to be analyzed by the mobile network service can include one or more of: a LIDAR data, a radar data, an image, a video, and V2X messages, or sensing data.

The time stamp can indicate the time the Service Request message is created. The deadline can refer to a time the ED 901 expects to receive the response from the SPF 909. In some aspects, the deadline could indicate an absolute time, e.g., in the format year-month-date hour-minute-second-millisecond. In some aspects the deadline can indicate a relative time from the time stamp, e.g., how many seconds or milliseconds after the time stamp the ED 901 expects to receive the response from the SPF 909.

At step 904, the EAIF 903 of an AN node can receive the message from the ED 901. The EAIF 903 can read the message. For example, the EAIF 903 can read the message header, amongst other information, to determine whether this message can be forwarded to a NF in the AN or in the CN that handles network-centric services. In some aspects, if the message is to request for or subscribe to a service being offered by the CN, the EAIF 903 can forward the message to the SPF 909 directly, or via one or more of the AN NCIF 905 and the CN NCIF 907.

At step 906, the EAIF 903 can send the message received at step 902 to the AN NCIF 905. The EAIF 903 may include one or more of information in the message in step 906: an AN ID, network ID, an AT type, an AT ID, the location of ED 901.

At step 908, the AN NCIF 905 can receive the message from the EAIF 903. The AN NCIF 905 can check whether the ED 901 is authorized to request the service. The AN NCIF 905 may have an ED Context information that includes authorization information indicating which services of the network the ED 901 may access. If the ED 901 is authorized to use the requested service, the AN NCIF 905 can forward the message received at step 906 to the CN NCIF 907. If the ED 901 is not authorized, the AN NCIF 905 can send a service reject message towards the ED 901. The service reject message can be sent to the EAIF 903, and then the EAIF 903 can send the service reject message to the ED 901.

At step 910, the CN NCIF 907 can receive the message from the AN NCIF 905 at step 908. The CN NCIF 907 can check whether the ED 901 is authorized to use the requested service. The CN NCIF 907 may have an ED Context of the ED 901 that includes authorization information. The authorization information may include information on which services the ED 901 may access. If the ED 901 is authorized to use the requested service, the CN NCIF 907 can forward the message received at step 908 to the corresponding SPF 909. If the ED 901 is not authorized to use the service, the CN NCIF 907 can send a reject message towards the ED 901 via one or more of: AN NCIF 905 and the EAIF 903.

At step 912, the SPF 909 can receive the service request or service subscription message sent at step 910 from the CN NCIF 907. The SPF 909 can send a message, e.g., a Service Authorization Request, to an Authorization Function such as Service Authorization Function 911. The message can include one or more of following information received from the EAIF 903: an ED ID, a requested service (which can be represented by a Service ID), a network ID, an AT type, an AT ID, an AN ID, an AN Node ID, a network slice ID, and a location (such as one or more of a geographic area ID, and AN Node ID).

At step 914, the Service Authorization Function 911 may have an ED Context or ED 901 profile which indicates the services the ED 901 may access. The Authorization Function, e.g., Service Authorization Function 911, can use the information provided in the message from the SPF 909 at step 910 and the ED Context to determine if ED 901 is authorized to use the service. The Service Authorization Function 911 can send a Service Authorization Response message to the SPF 909. The message can indicate whether the ED 901 is authorized to use the service or not, and the cause if the ED 901 is not authorized to use the service.

If the ED 901 is authorized to use the requested service, at step 916, the SPF 909 can provide the service that is requested by the ED 901.

The SPF 909 may then process the provided data. For example, the SPF 909 can process the provided data to detect one or more objects in one or more of: a photo, a video, a LIDAR, a radar file, and V2X messages, or any sensing data.

In some aspects, if the ED 901 requests data analytics information, the SPF 909 may need to and can collect necessary data from one or more data sources, such as sensing data from one or more of: AN nodes, and other EDs. The SPF 909 can then process the collected data and produce the requested analytics information.

After processing the data provided by the ED 901, or after producing the requested information, at step 918, the SPF 909 can send a message towards the ED 901 via the CN NCIF 907. In some aspects, the SPF 909 can send a Service Response if the ED 901 sent a Service Request message at step 902. In some aspects, the SPF 909 can send a Service Notification if the ED 901 sent a Service Subscription message at step 902. Each of the Service Response message and the Service Notification message can include one or more of following information: an ED ID, an ED location, a network slice ID, a Return Data, a real-time analytics (RTA) update, a Service Request ID, and a NF ID of the SPF 909.

The ED location can include one or more of following information: an AN ID, an AN node ID (e.g., a radio base station ID, a cell ID, a RAN ID, a network ID, an AT ID). The Return Data can refer to the data provided by the SPF 909 in response to the service request or subscription from the ED 901. For example, the Return Data can include one or more of: a detected object in data provided from the ED 901 (where the data provided can include one or more of: a photo, a video, a LIDAR, a radar signals), a location of the detected object, and a timestamp indicating the time the object is detected.

In some aspects, if the ED 901 subscribed for an RTA notification at step 902, the SPF includes one or more RTA update to the ED 901 in the Service Response or Notification message.

The Service Request ID in the Service Response or Notification message can be the same as the Service Request ID sent from the ED 901 at step 902. The NF ID of the SPF can be used to identify the SPF 909 that is providing the service to the ED 901. The NF ID can be one or more of: an IP address, and a FQDN.

At step 920, the CN NCIF 907 can receive the message sent from SPF 909 at step 918. The CN NCIF 907 can use at least one information element carried in the message, such as the ED ID, the AN ID, the AN node ID, the Cell ID, the Service Request ID, to identify the destination of the message. The CN NCIF 907 can then forward this message to the EAIF 903 directly or via the AN NCIF 905.

If the CN NCIF 907 sent the Service Response or Service Notification to the AN NCIF 905 at step 920, then at step 922, the AN NCIF 905 can use at least one information element carried in the message, such as the ED ID, the AN ID, the AN node ID, the Cell ID, and the Service Request ID, to identify the EAIF 903. The AN NCIF 903 can then forward this message to the EAIF 903.

At step 924, the EAIF 903 can receive the Service Response or Service Notification sent from the SPF 909 and forward the message to the ED 901.

If the ED 901 sent a Service Subscription message at step 902, the SPF 909 can continue performing data processing, as in step 926, for newly available data.

If a new data analytics result is available after sending the service response or notification at step 918, then at step 928, the SPF 909 can send a Service Notification message towards the ED 901 via the CN NCIF 907. The message can include some or all information included in the Service Response or Notification message sent at step 918.

In some aspects, if the ED 901 subscribed for RTA notifications 902, the SPF 909 can send RTA updates to the ED 901 in the Service Notification message. In some aspects, the RTA update can include real-time traffic density information, and time information. The time information, e.g. a timestamp, may indicate a time to apply the RTA update, such as a current time/duration, or a time/time duration in the past or future. In some aspects, the real-time traffic density information at a current time is sent if the current road traffic analytics indicate a difference from the real-time road traffic density sent earlier. In some aspects, the difference in road traffic analytics can be a percentage difference (x %), e.g., 10% compared to the RTA that has been sent to the ED earlier (at step 918).

At step 930, the CN NCIF 907 can receive the Service Notification message sent from SPF 909 at step 928. The CN NCIF 907 can use at least one information element carried in the message, such as the ED ID, the network ID, the AT type, the AT ID, the AN ID, the AN node ID, the Cell ID, the Service Request ID, to identify the destination of the message. The CN NCIF 907 can then forward this message to the EAIF 903 directly or via the AN NCIF 905.

If the CN NCIF 907 sent the Service Notification to the AN NCIF 905 at step 930, then at step 932, the AN NCIF 905 can use at least one information element carried in the message, such as the ED ID, the network ID, the AT type, the AT ID, the AN ID, the AN node ID, the Cell ID, and the Service Request ID, to identify the EAIF 903. The AN NCIF 903 can then forward this message to the EAIF 903.

At step 934, the EAIF 903 can receive the Service Notification sent from the SPF 909 and forward the message to the ED 901.

In some aspects, if the ED 901 sent a Service Subscription message at step 902, and the ED 901 may want to stop the Service Subscription when the service is no longer needed. Thus, at step 936, the ED 901 may determine that the service is no longer needed.

At step 938, the ED 901 can send a request to unsubscribe message towards the SPF 909 via the EAIF 903. The request to unsubscribe message can indicate a request to unsubscribe to the service of the SPF 909. The message can include a Service Request ID similar to the one sent in step 902, an indication to step the service, and other relevant information

At step 940, the EAIF 903 can receive the request to unsubscribe message from the ED 901. Based on the received request to unsubscribe message, the EAIF 903 can determine that the message is to be forwarded to the SPF 909. For example, the EAIF 903 can read and use the information carried in the request to unsubscribe message, e.g., at least one of: the Service Request ID, the ED ID, and the SPF ID, to determine the destination to forward the message. Thereafter, the EAIF 903 can then send the request to unsubscribe message to the SPF 909 directly, or via one or more of: the AN NCIF 905 and the CN NCIF 907.

When the AN NCIF 905 receives the request to unsubscribe message from the EAIF 903, at step 942, the AN NCIF 905 can read the message and use the information carried in the request to unsubscribe message, e.g., at least one of: the Service Request ID, the ED ID, and SPF ID, to determine the destination to forward the message. Thereafter, the EAIF 903 can send the request to unsubscribe message towards the SPF 909 directly, or via the CN NCIF 907.

If the CN NCIF 907 receives the request to unsubscribe message from the EAIF 903 or the AN NCIF 905, at step 944, the CN NCIF 907 can read the request to unsubscribe message and use the information carried in the message, such as at least one of the Service Request ID, the ED ID, and the SPF ID, to determine the destination to forward the message. Thereafter, the EAIF 903 can send the request to unsubscribe message to the SPF 909.

At step 946, the SPF 909 can receive the request to unsubscribe message from the CN NCIF 907. Thereafter, the SPF 909 can stop collecting and stop processing the data that is used to produce the service. In some aspects, the SPF 909 can send an Acknowledgement (ACK) to unsubscribe message towards the ED 901. The SPF 909 can send the ACK to unsubscribe message to the EAIF 903 directly, or via one or more of: NC NCIF 907 and the AN NCIF 905. The ACK to unsubscribe message can include one or more of the following information: an ED ID, a Service Subscription Stop ACK to acknowledge that the service subscription is terminated, the Service Request ID that the SPF 909 received at 902, an SPF ID, an AN ID, and an ED Location.

If the CN NCIF 907 receives the ACK to unsubscribe message from SPF 909 at step 946, then at step 948, the CN NCIF 907 can read the ACK to unsubscribe message and use the information carried in the message (e.g., one or more of: the Service Request ID, the ED ID, the AN ID, the ED Location, and the SPF ID) to determine the destination to forward the message. Thereafter, the CN NCIF 907 can send the message to the EAIF 903 directly, or via the AN NCIF 905.

If the AN NCIF 905 receives the ACK to unsubscribe message from the SPF 909 directly or via the CN NCIF 907, then at step 950, the AN NCIF 905 can read the ACK to unsubscribe message and use the information carried in the message (e.g., one or more of: the Service Request ID, the ED ID, the AN ID, the ED Location, and the SPF ID) to determine the destination to forward the message. Thereafter, the AN NCIF 905 can send the ACK to unsubscribe message towards the ED 901 via the ENIF 903.

At step 952, the EAIF 903 can receive the ACK to unsubscribe message from the SPF 909 directly or via one or more of: the CN NCIF 907 and the AN NCIF 905. The EAIF 903 can read the ACK to unsubscribe message and use the information carried in the message (e.g., the one or more of: the Service Request ID, the ED ID, the AN ID, the ED Location, and the SPF ID) to determine the ED 901 that should receive the ACK to unsubscribe message. Thereafter, the EAIF 903 can send the ACK to unsubscribe message towards the ED 901 via a medium such as a wireless or wired interface. The ED 901 can thereafter receive the ACK to unsubscribe message.

Aspects described herein may provide for a method for an ED 901 to directly request the services provided by a mobile network. In some aspects, the ED 901 can be configured with application information so that the ED 901 is aware of available network services. Thus, the ED 901 can be configured to send messages to access the network services. Aspects described herein may further provide the AN to detect the messages that are to be sent to NF in the CN that provide the requested services.

Aspects described herein may provide for enhanced network architecture and interfaces that separate the ED-centric services and the network-centric services. Aspects described herein may provide for a NF in the AN to register its services in the CN NF Database by using network-centric services.

As described herein, the profile of the AN NF or the ED that can provide data (e.g., sensing data) can include one or more of following information: a Network ID, an AT type, an AT ID, an AN ID, a network slice ID, a NF ID in the case of an AN NF profile, a Device ID in the case of an ED profile, an address of the NF, a type of data, a location information, and operation hours.

The Network ID can be the ID that can be used to identify the mobile network. The AT type can indicate the type of access technology such as 4G, 5G, 6G, WiFi, optical fiber. The AT ID can be the identifier of AT type. The AN ID can be the identifier of the AN that may provide the requested sensing data. The network slice ID can refer to one or more of: the ID of the network slice of the network or the ID of the network slice of the AN.

The address of the NF can include one or more of following information: an IP address, a port number, and a FQDN. The type of data can indicate a type of sensing data that can be produced. The Location information can refer to the location the sensing data are to be collected.

The operation hours can indicate a time window during which the sensing data can be produced. The operation hours can be represented by a start time and an end time, wherein each of the start time and the end time can be associated with a day and be indicated in terms of one or more of: hours, minutes and seconds. In some aspects, the operation hours can be an interval with a start time and an end time, wherein each of the start time and the end time can be indicate via one or more of: hour, minute, second, year, month, and date.

Aspects described herein may provide for a CN NCIF 907 that can receive an AN NF Registration message from an AN NF. The CN NCIF 907 can then forward the registration message to a NF Database, such as NF database 128.

Aspects described herein may provide for a method to separate mobility management and network service access for an ED 901. For example, aspects described herein may provide for an A NF interface function in the AN (e.g., EAIF 903 via the AN NCIF 905 or an AN ECIF) to forward one or more CP messages to either AN ECIF or CN NCIF 907 in the CN.

Aspects described herein, including the enhanced network architecture, separate CP interfaces and corresponding methods related thereto, can be applicable to 6G mobile network, as may be appreciated by a person skilled in the art.

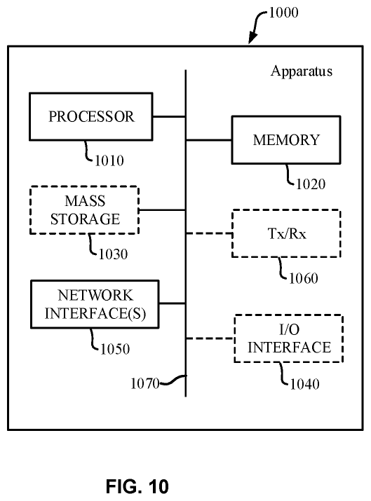

FIG. 10 illustrates an apparatus 1000 that may perform any or all of operations of the above methods and features explicitly or implicitly described herein, according to different aspects of the present disclosure. For example, a computer equipped with network function may be configured as the apparatus 1000. In some aspects, the apparatus 1000 can be an ED, such as ED 140. In some aspect, apparatus 1000 can a device that connects to the network infrastructure over a radio interface, such as a mobile phone, smart phone or other such device that may be classified as user equipment (UE). In some aspects, the apparatus 1000 may be a Machine Type Communications (MTC) device (also referred to as a machine-to-machine (m2m) device), or another such device that may be categorized as a UE despite not providing a direct service to a user. In some aspects, apparatus 1000 may be used to implement one or more aspects described herein. For example, the apparatus 1000 may be configured to perform operations performed by one or more of ED 140 and functions described herein.

As shown, the apparatus 1000 may include a processor 1010, such as a Central Processing Unit (CPU) or specialized processors such as a Graphics Processing Unit (GPU) or other such processor unit, memory 1020, non-transitory mass storage 1030, input-output interface 1040, network interface 1050, and a transceiver 1060, all of which are communicatively coupled via bi-directional bus 1070. According to certain aspects, any or all of the depicted elements may be utilized, or only a subset of the elements. Further, apparatus 1000 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 1020 may include any type of non-transitory memory such as static random-access memory (SRAM), dynamic random-access memory (DRAM), synchronous DRAM (SDRAM), read-only memory (ROM), any combination of such, or the like. The mass storage element 1030 may include any type of non-transitory storage device, such as a solid-state drive, hard disk drive, a magnetic disk drive, an optical disk drive, USB drive, or any computer program product configured to store data and machine executable program code. According to certain aspects, the memory 1020 or mass storage 1030 may have recorded thereon statements and instructions executable by the processor 1010 for performing any of the aforementioned method operations described above.

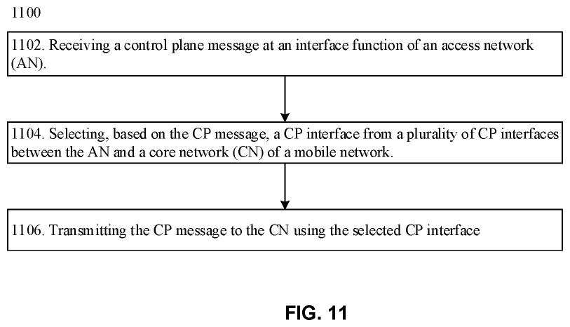

FIG. 11 illustrates a method 1100 for communicating between an AN and a CN, according to an aspect of the present disclosure. In some aspects, the method 1100 can be performed by an EAIF, such as EAIF 122. The method 1100 includes, at block 1102, receiving a CP message at an interface function of an access network (AN). The method 1100 further includes, at block 1104, selecting, based on the CP message, a CP interface from a plurality of CP interfaces between the AN and the CN of a mobile network. The method 1100 further includes, at block 1106, transmitting the CP message to the CN using the selected CP interface.

In some aspects, selecting a CP interface comprises selecting a CP interface based on an indicator included in the CP message. In some aspects selecting a CP interface comprises selecting a CP interface between: a first interface (e.g., C1 146) used for electronic device (ED)-centric CP signaling, including access and mobility CP messages, and a second interface (e.g., C2 148) used for network-centric CP signaling.

In some aspects, the CP message comprises a message for discovering a network service and wherein selecting a CP interface comprises selecting the first interface (e.g., C1 146).

In some aspects, the CP message comprises a message for accessing a network service and wherein selecting a CP interface comprises selecting the second interface (e.g., C2 148).

In some aspects, receiving a CP message comprises receiving a CP message from an ED (e.g., ED 140). In some aspects, transmitting the CP message to the CN comprises transmitting the CP message to an SPF associated with the CN.

In some aspects, receiving a CP message comprises receiving a CP message at the EAIF 122.

Aspects of the present disclosure can be implemented using electronics hardware, software, or a combination thereof. In some aspects, this may be is implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific aspects of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding aspects, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the aspects of the present invention. For example, such an execution may correspond to a simulation of the logical operations as described herein. The software product may additionally or alternatively include a number of instructions that enable a computer device to execute operations for configuring or programming a digital logic apparatus in accordance with aspects of the present invention.

Although the present invention has been described with reference to specific features and aspects thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method comprising:
receiving a control plane (CP) message at an interface function of an access network (AN);
selecting, based on the CP message, a CP interface from a plurality of CP interfaces between the AN and a core network (CN) of a mobile network; and
transmitting the CP message to the CN using the selected CP interface.

2. The method of claim 1, wherein selecting the CP interface comprises selecting the CP interface based on an indicator included in the CP message.

3. The method of claim 1, wherein selecting the CP interface comprises selecting the CP interface between a first interface used for electronic device (ED)-centric CP signaling, including access and mobility CP messages and a second interface used for network-centric CP signaling.

4. The method of claim 3, wherein the CP message comprises a message for discovering a network service and wherein selecting the CP interface comprises selecting the first interface.

5. The method of claim 3, wherein the CP message comprises a message for accessing a network service and wherein selecting the CP interface comprises selecting the second interface.

6. The method of claim 1, wherein receiving the CP message comprises receiving the CP message from an ED, and wherein transmitting the CP message to the CN comprises transmitting the CP message to a service provider function (SPF) associated with the CN.

7. The method of claim 1, wherein receiving the CP message comprises receiving the CP message at an ED-AN interface function (EAIF).

8. The method of claim 1, wherein transmitting the CP message to the CN using the selected CP interface comprises transmitting the CP message using one of an AN network-centric interface function and an AN ED-centric interface function.

9. A method of providing services to an electronic device (ED) from an electronic device-access network interface function (EAIF), the method comprising:
receiving, by the EAIF, a request for service from the ED, wherein the service is provided by a service provider function (SPF) in a core network (CN) of a mobile network, and wherein the EAIF is associated with an access network (AN);
transmitting the request for service over a first interface between the AN and the CN;
receiving a first response indicating that the ED is authorized to use the service;
assigning one or more AN resources to service data communication between the ED and the SPF; and
sending, to the ED, a second response based on the first response.

10. The method of claim 9, wherein receiving the request for service comprises receiving the request for service including at least one of an ED identifier (ID), an ED location, an application ID, a service ID, destination information, a data network name (DNN), a network slide ID, a location of the requested service, data to be analyzed, a travel path, a waypoint, a location and a corresponding time window, an accuracy of road analytic information, and a type of road analytic information.

11. The method of claim 9, wherein transmitting the request for service comprises transmitting the request for service through at least one of an AN ED-centric interface function (ECIF) and a CN ECIF.

12. The method of claim 9, wherein receiving the first response comprises receiving the first response through at least one of an AN ECIF and a CN ECIF.

13. The method of claim 9, wherein receiving the first response comprises receiving the first response including at least one of an ED identifier (ID), an ED location, an indication of service acceptance or service rejection, a cause for service rejection when an indication of service rejection is present, a service location, a time window for the service, a network function (NF) ID of the SPF, address information of the SPF, a service ID, an application ID, a data network name (DNN), a network slice information, a NF ID of a selected CN network-centric interface function (NCIF), a NF ID of a selected AN NCIF, and an EAIF NF ID, and
wherein sending the second response comprises sending the second response including at least one of an ED identifier (ID), an indication of service acceptance or service rejection, a cause for service rejection when an indication of service rejection is present, a service location, a time window for the service, a network function (NF) ID of the SPF, address information of the SPF, a service ID, an application ID, a data network name (DNN), and a network slice information.

14. The method of claim 9, further comprising:
receiving, from the ED, a data message associated with the service;
sending the data message toward the SPF;
receiving, from the SPF, a service result message based on the data message; and
sending, to the ED, the service result message.

15. The method of claim 14, wherein receiving the data message comprises receiving the data message including at least one of a destination information associated with the SPF, a data network name (DNN), a network slice identifier (ID), and a service container message.

16. The method of claim 14, wherein sending the data message toward the SPF comprises sending the data message toward the SPF via at least one of an AN NCIF and a CN NCIF.

17. The method of claim 14, wherein receiving the service result message comprises receiving the service result message including at least one of a destination information associated with the EAIF, an ED identifier, and an ED container message, wherein the ED container message comprises at least one of an ED ID, a service request ID, a service acknowledgment to indicate that the service requested is fulfilled, a list of detected objects and their corresponding attributes, an accuracy of detection of object detection, and a timestamp of the service result message.

18. The method of claim 14, wherein receiving the service result message comprises receiving the service result message via at least one of an AN NCIF, and a CN NCIF.

19. An apparatus comprising:
at least one processor; and
at least one machine-readable medium storing executable instructions which when executed by the at least one processor configure the apparatus to:
receive a control plane (CP) message at an interface function of an access network (AN);
select, based on the CP message, a CP interface from a plurality of CP interfaces between the AN and a core network (CN) of a mobile network; and
transmit the CP message to the CN using the selected CP interface.

20. An apparatus comprising:
at least one processor; and
at least one machine-readable medium storing executable instructions which when executed by the at least one processor configure the apparatus to:
receive, by an electronic device-access network interface function (EAIF), a request for service from an electronic device (ED), wherein the service is provided by a service provider function (SPF) in a core network (CN) of a mobile network, and wherein the EAIF is associated with an access network (AN);
transmit the request for service over a first interface between the AN and the CN;
receive a first response indicating that the ED is authorized to use the service;
assign one or more AN resources to service data communication between the ED and the SPF; and
send, to the ED, a second response based on the first response.
